(19) United States
(12) Patent Application Publication
(10) Pub. No.: US 2026/0077344 A1
(43) Pub. Date: Mar. 19, 2026

(54) SPECIMEN STORAGE AND SPECIMEN PREPARATION DEVICE

(71) Applicant: HIRATA CORPORATION, Kumamoto-shi (JP)

(72) Inventors: Kenji MORITA, Kumamoto-shi (JP); Taiga TAKETSU, Kumamoto-shi (JP)

(73) Assignee: HIRATA CORPORATION, Kumamoto-shi (JP)

(21) Appl. No.: 19/398,170

(22) Filed: Nov. 24, 2025

Related U.S. Application Data
(63) Continuation of application No. PCT/JP2023/022639, filed on Jun. 19, 2023.

(51) Int. Cl. B01L 1/00

(52) U.S. Cl. CPC B01L 1/00; B01L 2300/043; B01L 2300/0609; B01L 2300/0627

(57) ABSTRACT

A specimen storage for storing an observation specimen obtained by providing an observation object on a light transmissive plate, comprises an opening and closing member that is movably attached to a main body of the specimen storage in one direction, and an abutting member configured to be able to abut on a case for housing observation specimens, wherein the opening and closing member is provided to be movable with respect to the main body so as to abut on the case when the opening and closing member is a closing state and to be separated from the case when the opening and closing member is an opening state.

### CROSS-REFERENCE TO RELATED APPLICATION(S)

This application is a continuation of International Patent Application No. PCT/JP2023/022639 filed on Jun. 19, 2023, the entire disclosures of which is incorporated herein by reference.

### TECHNICAL FIELD

The present invention mainly relates to a specimen storage.

### BACKGROUND ART

An observation specimen used for microscopic observation or the like is generally prepared by providing an observation object such as a tissue piece on a light transmissive plate also referred to as a microscope slide or the like (see Patent Literature 1).

### CITATION LIST

### Patent Literature

PTL1: Japanese Patent Laid-Open No. 2010-266394
PTL2: Japanese Patent Laid-Open No. 2010-054473
PTL3: Japanese Patent Laid-Open No. 2014-095587

### SUMMARY OF INVENTION

### Technical Problem

In a specimen preparation device for preparing an observation specimen, the observation specimen prepared as described above is stored or held at a predetermined position in the device until being taken out of the device (see Patent Literatures 2 and 3). For this reason, a technique capable of appropriately storing the observation specimen at a predetermined position is generally required.

An exemplary object of the present invention is to achieve storage of an observation specimen at a predetermined position with a relatively simple configuration.

### Solution to Problem

One aspect of the present invention is a specimen storage, for storing an observation specimen obtained by providing an observation object on a plate, the specimen storage comprising:
a case placement portion that can place a case for housing an observation specimen;
a main body that includes an opening communicating so as to allow the case to move;
an opening and closing member that is movably attached to the main body in one direction;
an abutting member configured to be able to abut on one of the cases for housing observation specimens; and
a movement mechanism that moves the opening and closing member, wherein
the opening and closing member is provided to be movable between an open position at which the opening is opened and a closed position at which the opening is closed,
the abutting member is provided to be movable to an abutting position at which the abutting member abuts on the case placed in the case placement portion and a separated position at which the abutting member is separated from the case so as to be able to take out the case from the case placement portion, and
the movement mechanism moves the abutting member based on movement of the opening and closing member.

### Advantageous Effects of Invention

According to the present invention, it is possible to achieve the storage of the observation specimen at a predetermined position with a relatively simple configuration.

### BRIEF DESCRIPTION OF DRAWINGS

FIG. 1 is a perspective view illustrating a configuration example of a specimen preparation system.

FIG. 2 is a top view and a front view illustrating the configuration example of the specimen preparation system.

FIG. 3 is a perspective view illustrating the appearance of a specimen preparation device from diagonally above the front.

FIG. 4 is a perspective view illustrating the appearance of the specimen preparation device from diagonally above the back.

FIG. 5 is a perspective view illustrating an internal configuration example of the specimen preparation device.

FIG. 6 is a perspective view for explaining each mechanism of an observation object provision unit.

FIG. 7 is a schematic diagram for explaining an example of work contents in the specimen preparation device.

FIG. 8 is a diagram for explaining a configuration example of a placement member.

FIG. 9 is a side view for explaining each mechanism of the observation object provision unit.

FIG. 10 is a schematic diagram for explaining an example of a method of preparing an observation specimen.

FIG. 11 is a schematic diagram for explaining an example of the method of preparing an observation specimen.

FIG. 12 is a schematic diagram for explaining an example of the method of preparing an observation specimen.

FIG. 13 is a perspective view for explaining a configuration example of a post-processing unit.

FIG. 14 is a diagram for explaining a configuration example of a specimen storage unit.

FIG. 15 is a perspective view illustrating an example of a configuration of the specimen storage unit.

FIG. 16A is a schematic side view illustrating an example of a configuration of an opening and closing member.

FIG. 16B is a schematic side view illustrating an example of the configuration of the opening and closing member.

FIG. 17 is a diagram illustrating an example of a system configuration of the specimen preparation device.

FIG. 18 is a diagram illustrating an example of a display image for managing an observation specimen.

FIG. 19 is a perspective view illustrating an example of an internal structure of the specimen storage unit.

### DESCRIPTION OF EMBODIMENTS

Hereinafter, embodiments will be described in detail with reference to the accompanying drawings. Note that the following embodiments do not limit the invention according to the claims, and not all combinations of features described in the embodiments are necessarily essential to the invention. Two or more features of a plurality of features described in the embodiments may be arbitrarily combined. In addition, the same or similar configurations are denoted by the same reference signs, and redundant description will be omitted.

### Regarding Specimen Preparation System

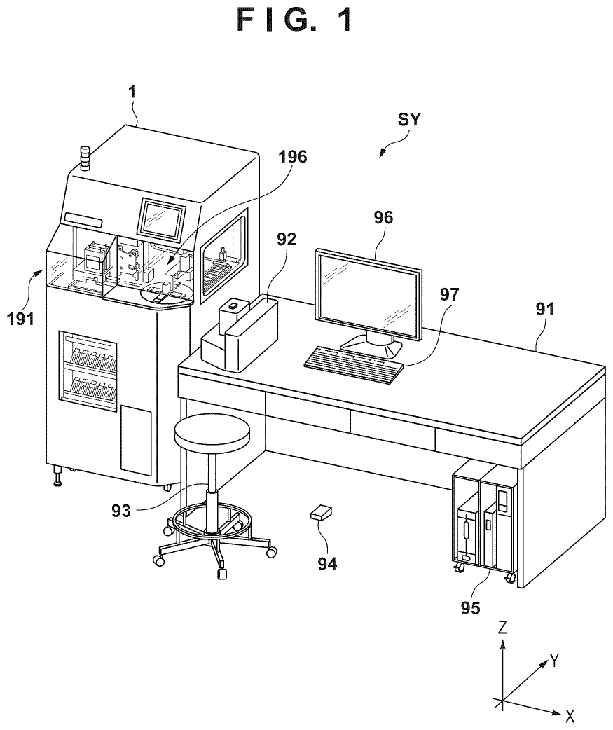

FIG. 1 is a perspective view illustrating an overall configuration example of a specimen preparation system SY according to an embodiment. The system SY includes a specimen preparation device 1, a working table 91, an observation object preparation device 92, a chair 93, an input device 94, a computer 95, a display terminal 96, and an input terminal 97.

Here, in the drawing, an X direction, a Y direction, and a Z direction intersecting each other are illustrated for easy understanding (They may also be illustrated in other drawings described below.). The X direction is one direction in the horizontal direction of the specimen preparation device 1, and corresponds to the left-right direction or the width direction. The Y direction is another direction orthogonal to the one direction in the horizontal direction of the specimen preparation device 1, and corresponds to the front-back direction or the depth direction. The Z direction is a vertical direction of the specimen preparation device 1 and corresponds to the up and down direction or the height direction. For example, the side in the −Y direction corresponds to the front side, and the side in the +Y direction corresponds to the back side. In addition, for example, the side in the +Z direction corresponds to the upper side, and the side in the −Z direction corresponds to the lower side.

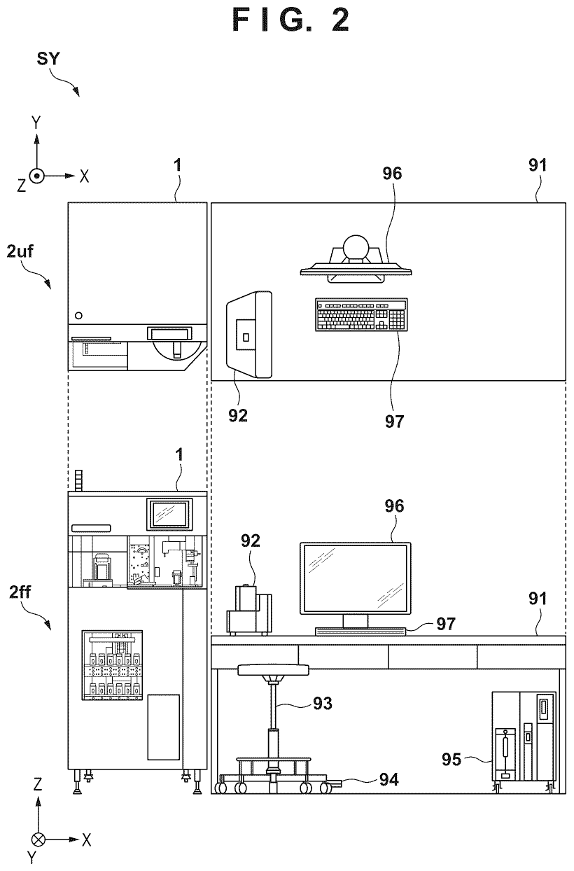

FIG. 2 illustrates a top view 2uf and a front view 2ff of the system SY.

Although details will be described later, the specimen preparation device 1 prepares a predetermined observation specimen using an observation object provided by an entity performing the work. Here, the observation object is a tissue piece obtained by slicing a block formed by solidifying a tissue collected from a subject such as a patient with paraffin or the like (an observation object OB to be described later). The observation specimen is prepared by placing the observation object on a light transmissive plate (an observation specimen SPL to be described later). This plate can also be expressed as a microscope slide, a specimen plate, an observation object placing plate, an optical observation plate, or the like (a plate PL to be described later). In addition, the entity performing the work is an entity that performs work related to specimen preparation, and is typically a worker such as an engineer, but may be a work robot including a provision mechanism (a manipulator or the like) for providing an observation object. In the present embodiment, the entity performing the work is referred to as a “worker”, and hereinafter, simply referred to as a “worker”.

The working table 91 is a desk for the worker to perform work accompanying the preparation of the observation specimen. The observation object preparation device 92, the display terminal 96, and the input terminal 97 are installed on the working table 91. Using them, the worker can also perform work (for example, management, recording, and the like of information related to the observation specimen) on the working table 91. The worker can also perform other work (for example, writing work). The specimen preparation device 1 and the working table 91 are arranged side by side in the X direction, that is, the working table 91 is installed on the side (here, the side in the +X direction) of the specimen preparation device 1.

In the present embodiment, the observation object preparation device 92 is a microtome for preparing a tissue piece as an observation object, but as another embodiment, for example, another device such as a medical device or an experimental device may be used. Although details will be described later, the observation object preparation device 92 is installed on the specimen preparation device 1 side on the working table 91.

In the present embodiment, the chair 93 is a chair with casters. As a result, when the worker performs work, the worker can easily move back and forth between the specimen preparation device 1 and the working table 91 while sitting on the chair 93.

In the present embodiment, the input device 94 is a foot switch installed below the working table 91, and the worker can perform a predetermined operation input by pressing the input device 94 with his/her foot. The input device 94 is electrically connected to the specimen preparation device 1 by a cable (not illustrated), and although details will be described later, the specimen preparation device 1 advances the work step in response to the predetermined operation input to the input device 94.

Note that, as another embodiment, the input device 94 may be wirelessly connected to the specimen preparation device 1. In addition, as another embodiment, the input device 94 may be installed on the working table 91.

Furthermore, instead of the foot switch, a lever, a joystick, or the like operated by a hand or a foot of the worker may be adopted, or various motion sensors or the like operated by movement of a head, an eye, a hand, or a foot may be adopted.

Furthermore, the input device 94 may be a device that performs input by recognizing voice, thought, and the like of the worker.

The computer 95 is a general-purpose computer, and here, is installed below the working table 91. In this case, by installing the computer 95 on the side opposite to the specimen preparation device 1 side, it is possible to prevent the worker from erroneously interfering with the computer 95. A known display or monitor such as a liquid crystal display can be used as the display terminal 96. A known input operator such as a keyboard or a mouse can be used as the input terminal 97. For example, the worker can perform information management related to the observation specimen using the input terminal 97 while visually recognizing the plate and the information indicating the observation object with the display terminal 96.

### Regarding Specimen Preparation Device

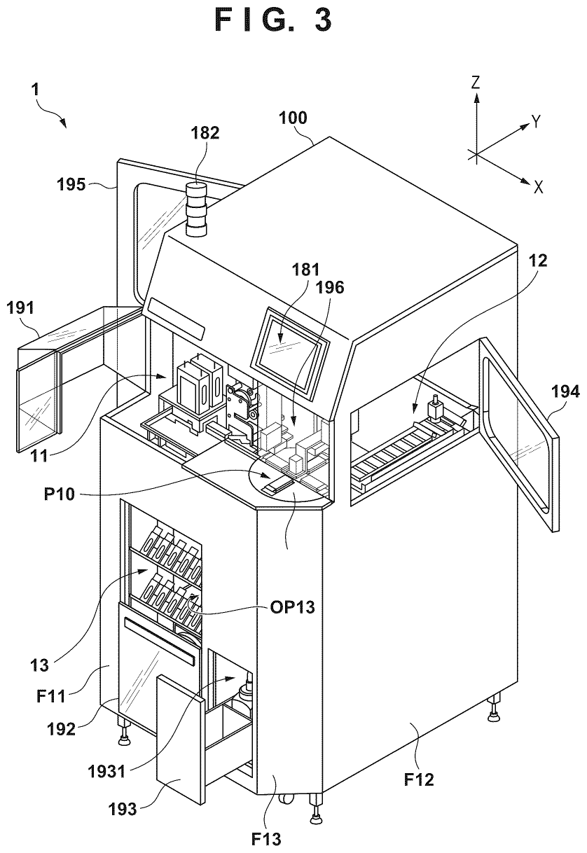

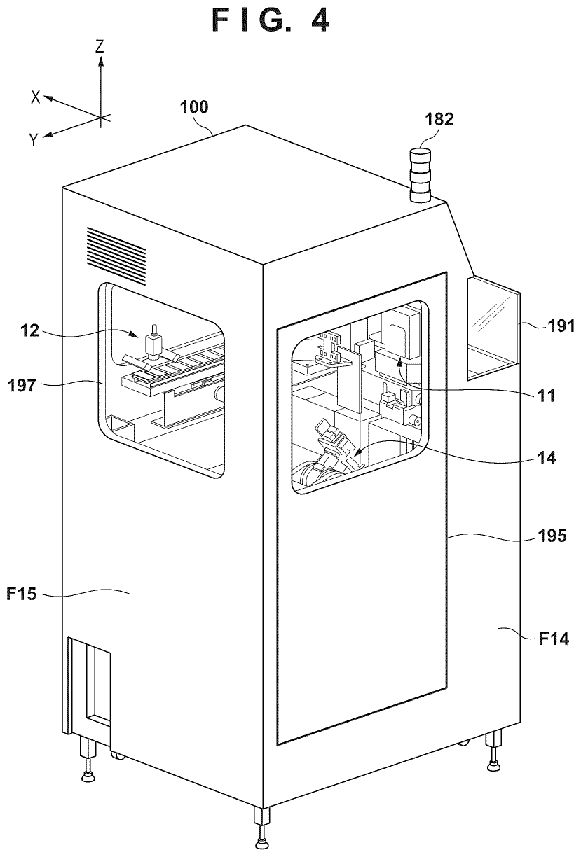

FIG. 3 is a perspective view of the specimen preparation device 1 from diagonally above the front. FIG. 3 illustrates the specimen preparation device 1 in a state where a plurality of opening and closing members are opened (Hereinafter, it may be simply referred to as an “open state”.). FIG. 4 is a perspective view of the specimen preparation device 1 from diagonally above the back. FIG. 4 illustrates the specimen preparation device 1 in a state where the plurality of opening and closing members are closed (Hereinafter, it may be simply referred to as a “closed state”.). The device 1 includes a housing 100 including an exterior panel, and a plurality of units (described later) that implement functions of the device 1 are housed in the housing 100.

The specimen preparation device 1 further includes parts 191 to 197 attached to the individual portions (such as F11 described later) of the housing 100. Although individual details will be described later, for example, an opening and closing member 191, an opening and closing member 192, a housing unit 193, and a plate member 196 are provided as the parts on a front wall portion (front panel) F11 of the housing 100. For example, an opening and closing member 194 is provided on a side wall portion (side panel) F12 of the housing 100 on the working table 91 side. For example, an opening and closing member 195 is provided on a side wall portion (side panel) F14 opposite to the side wall portion F12 of the housing 100. In addition, for example, a window member 197 is provided on a back wall portion (back panel) F15 of the housing 100.

Although details will be described later, at least the opening and closing member 192 among the opening and closing members 191, 192, 194, and 195 is a sliding door slidably attached in one direction, and here, the opening and closing member 192 slides in the Z direction. In the present embodiment, the other opening and closing members 191, 194, and 195 are rotary doors pivotally supported at one end portion, but may be doors of other known types, or may be sliding doors similar to the opening and closing member 192.

A corner side wall portion (corner panel) F13 is provided at a corner portion between the front wall portion F11 and the side wall portion F12, and the corner side wall portion F13 is connected to one end portion (or one edge portion) of the front wall portion F11 and one end portion of the side wall portion F12. That is, the housing 100 has a shape (chamfered shape) chamfered at the corner portion. The wall portions F11 to F15 described above form the exterior panel of the housing 100, and all or a part of them may be integrally molded or may be separate portions. Note that the side wall portion F12 corresponds to one side wall portion, and the side wall portion F14 corresponds to the other side wall portion.

An operation display panel 181 is provided on the upper front surface of the housing 100, and the worker can confirm an operation status (including work progress and the like) of the specimen preparation device 1 on the basis of display contents displayed on the operation display panel 181. In addition, various settings of the specimen preparation device 1 can be input to the operation display panel 181. Examples of the input of various settings include information input of identification information 1131 to be described later, setting input of a temperature management time in a heating unit 122 to be described later, and temperature setting input of the inside of the specimen preparation device 1. Furthermore, it is also possible to input, to the operation display panel 181, an operation for manually operating various units and an automatic operation for automatically operating various units.

Note that a known touch panel display can be used as the operation display panel 181, and the operation display panel 181 may be simply expressed as an operation panel, a display panel, or the like. The function of the operation display panel 181 may be implemented by the display terminal 96, and in this case, the operation display panel 181 may be omitted.

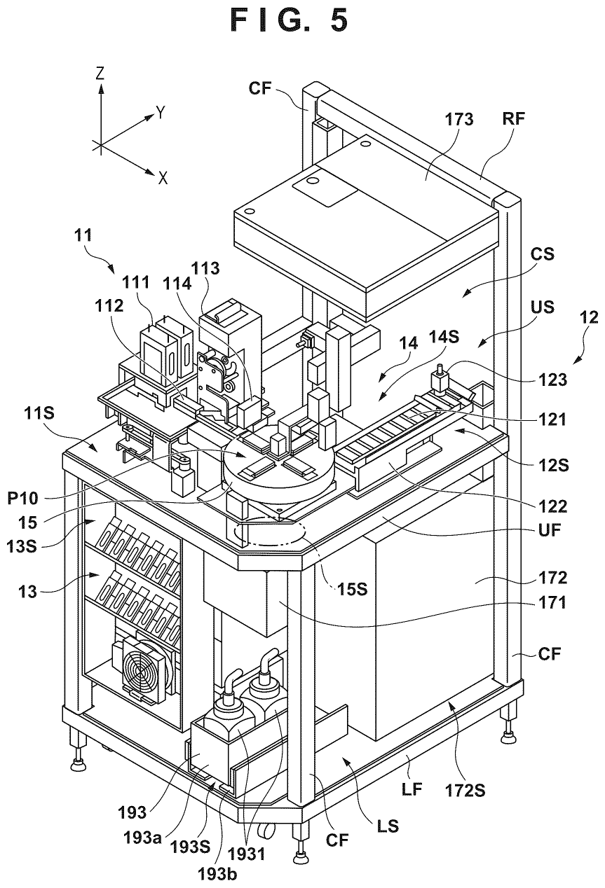

FIG. 5 is a perspective view illustrating the internal structure of the specimen preparation device 1. The device 1 includes a pre-processing unit 11, a post-processing unit 12, a specimen storage unit 13, a transfer unit 14, and an observation object provision unit 15. Although details will be described later, the pre-processing unit 11 includes units 111 to 114 that perform pre-processing that is processing before provision of the observation object. In addition, the post-processing unit 12 includes units 121 to 123 that perform post-processing that is processing after provision of the observation object.

The specimen storage unit 13 is a unit that stores (or houses or keeps) the prepared observation specimen. The specimen storage unit 13 may be simply expressed as a storage unit, or may be expressed as a specimen housing unit (or simply a housing unit), a specimen keeping unit (or simply a keeping unit), or the like. Since the specimen storage unit 13 is surrounded by the exterior panel of the housing 100 and sealed by the opening and closing member 192 in a closed state, the specimen storage unit 13 may be expressed as a specimen storage, a specimen housing, a specimen keeper, or the like. In this case, the opening and closing member 192 may be a part of the specimen storage unit 13.

In the present embodiment, the transfer unit 14 is a manipulator capable of gripping the plate, and receives a plate to which the observation object is provided from the post-processing unit 12 as an observation specimen SPL and transfers the plate to the specimen storage unit 13.

Although details will be described later, the observation object provision unit 15 is configured to be accessible when the worker provides the observation object. The unit 15 is installed at an access point (referred to as an observation object providing position or simply, a providing position P10) by the worker at the time of providing the observation object. The unit 15 may be expressed as a unit for work entity access or the like from the viewpoint of an access target by the worker, or may be expressed as an observation object reception unit or the like from the viewpoint of receiving an observation object from the worker.

The specimen preparation device 1 further includes control units 172 to 173. For example, the control unit 172 executes drive control of the pre-processing unit 11, the unit 15, and the post-processing unit 12, and also executes management control of the entire specimen preparation device 1. In addition, the control unit 173 executes dedicated drive control for driving the transfer unit 14. As another embodiment, a part of the functions of any unit (for example, the unit 173) may be implemented by another unit (for example, the unit 172), or all or a part of the functions may be implemented by a single unit.

The control units 172 to 173 may typically be configured to incorporate a control board on which electronic components such as an application specific integrated circuit (ASIC) are mounted, but are not limited to this configuration. For example, the control units 172 to 173 may be configured to include a central processing unit (CPU) and a memory, and these functions may be implemented by a computer executing a program. That is, the function of each of the control units 172 to 173 may be implemented by either hardware or software.

Each of the elements described above is fixed to a frame member or a base that supports the exterior panel of the housing 100 by fastening using, for example, a bolt, a screw, or the like. In the present embodiment, the housing 100 includes an upper support member UF, a lower support member LF, and a coupling support member CF. The pre-processing unit 11, the post-processing unit 12, and the unit 15 are arranged on the upper support member UF. The lower support member LF is provided below the upper support member UF with a space therebetween. The coupling support member CF couples the upper support member UF and the lower support member LF. The housing 100 is defined by an upper space US and a lower space LS with the upper support member UF as a boundary. The upper space US is a space in which the pre-processing unit 11, the post-processing unit 12, and the unit 15 are arranged, and the lower space LS is a space in which the specimen storage unit 13 is disposed. In addition, the upper space US and the lower space LS communicate with each other to form a communication space CS. The communication space CS is a transfer space of the observation specimen SPL transferred from the post-processing unit 12 to the specimen storage unit 13 by the transfer unit 14.

The pre-processing unit 11 and the unit 15 are installed on the front wall portion F11 side and substantially at the central portion in the Z direction in the housing 100. The housing 100 further includes a pre-processing disposing portion 11S in which the pre-processing unit 11 is disposed at a predetermined height on the front wall portion F11 side, and an observation object provision disposing portion 15S in which the unit 15 is disposed. The pre-processing unit 11 is located on the side wall portion F14 side, and the unit 15 is located on the side wall portion F12 side. The unit 15 is located close to the corner side wall portion F13. Similarly, the pre-processing disposing portion 11S is provided on the side wall portion F14 side, the observation object provision disposing portion 15S is provided on the side wall portion F12 side, and the observation object provision disposing portion 15S is provided at a position close to the corner side wall portion F13. In the case of the present embodiment, the pre-processing disposing portion 11S and the observation object provision disposing portion 15S are provided on the upper support member UF.

The post-processing unit 12 is installed on the side wall portion F12 side and substantially at the central portion in the Z direction in the housing 100, and is provided alongside the unit 15 in the Y direction. The housing 100 further includes a post-processing disposing portion 12S at a position close to the side wall portion F12. In the case of the present embodiment, the post-processing disposing portion 12S is provided on the lower support member LF. The specimen storage unit 13 is installed below the pre-processing unit 11 in the housing 100. The housing 100 further includes a specimen storage disposing portion 13S below the pre-processing disposing portion 11S. In the case of the present embodiment, the specimen storage unit 13 is disposed in the lower space LS, and the specimen storage disposing portion 13S is provided on the upper support member UF.

The control unit 172 is installed below the post-processing unit 12 in the housing 100. In addition, the control unit 173 is installed in the upper part of the housing 100. The housing 100 further includes a first control unit disposing portion 172S in which the control unit 172 is disposed below the post-processing disposing portion 12S. In the case of the present embodiment, the first control unit disposing portion 172S is provided on the lower support member LF. In addition, the housing 100 further includes a second control unit disposing portion 173S in which the control unit 173 installed in the upper part of the housing is disposed. In the case of the present embodiment, the second control unit disposing portion 173S is provided in a coupling member RF extended between the coupling support members CF on the upper space US side above the upper support member UF.

The transfer unit 14 is installed on the back wall portion F15 side in the housing 100. The transfer unit 14 can rotate about the Z direction as an axis while moving its distal end in the Z direction, and can access both the post-processing unit 12 and the specimen storage unit 13 by the present installation mode. The housing 100 further includes a transfer unit disposing portion 14S on the back wall portion F15 side. In the case of the present embodiment, the transfer unit disposing portion 14S is provided on the lower support member LF. The distal end of the transfer unit 14 is movably disposed over the upper space US, the lower space LS, and the communication space CS.

Furthermore, in the housing 100, the housing unit 193 that houses a liquid tank 1931 is further installed below the unit 15. The liquid tank 1931 stores a liquid to be used for preparing an observation specimen to be described later.

The liquid tank 1931 may be expressed as a liquid storage (or simply a storage), a container, or the like. The housing unit 193 includes a housing member 193a that houses the liquid tank 1931, and a movement mechanism 193b that causes the housing member 193a to be movable between a housed position and a withdrawn position. The housing member 193a can be withdrawn in the −Y direction as illustrated in FIG. 3 from a state of being housed in the housing 100 by the movement mechanism 193b. As a result, the worker can access the liquid tank 1931 housed in the housing 100 (the housing member 193a). For example, by withdrawing the housing member 193a, the worker can replenish the liquid tank 1931 with liquid or replace the old liquid tank 1931 housed in the housing member 193a with a new one. In the case of the present embodiment, a housing disposing portion 193S is provided on the lower support member LF.

### Regarding Observation Object Provision Unit

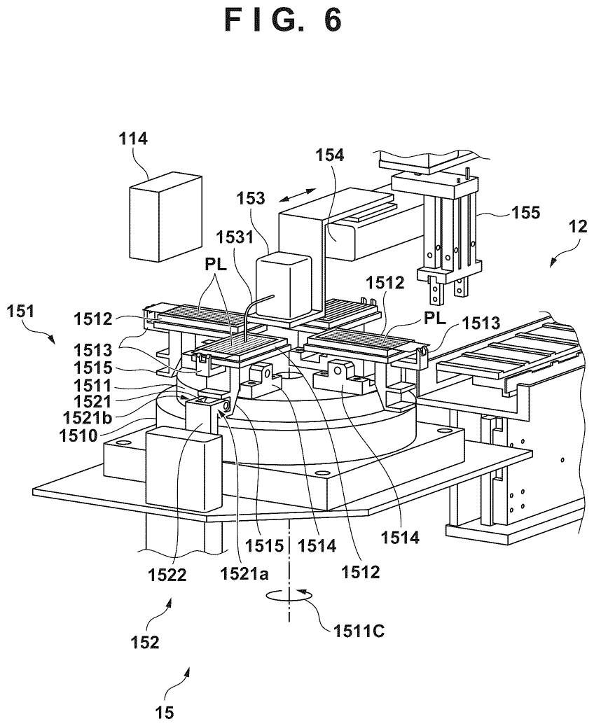

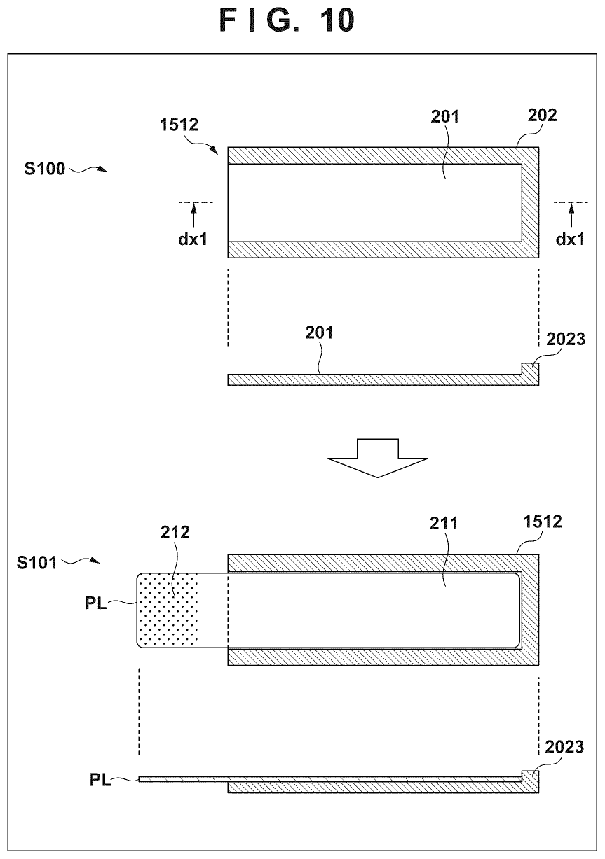

FIG. 6 is a perspective view illustrating a state of the observation object provision unit 15 described above and a peripheral region thereof. FIG. 9 is a partially enlarged view of the unit 15. The unit 15 includes a moving unit 151, a tilting mechanism 152, and a liquid supply unit 153. In addition, the unit 15 further includes a transfer unit 155 that transfers the observation specimen SPL between the unit 15 and the post-processing unit 12.

The moving unit 151 includes a base 1510, a movement support base (or a rotation support base) 1511, a holding portion 1512, and the tilting mechanism 152.

The tilting mechanism 152 includes a tilting fixed body 1514b, a tilting movable body 1514a, an engaging portion 1515, and an elevating mechanism 1522. The tilting fixed body 1514b is supported on the movement support base 1511. The tilting movable body 1514a is movably supported with respect to the tilting fixed body 1514b. In the engaging portion 1515, the elevating mechanism 1522 configured on one end portion side of the tilting movable body 1514a is locked to the engaging portion 1515 to move the tilting movable body 1514a. The elevating mechanism 1522 includes a moving and locking portion 1521 that is locked to the engaging portion 1515, and an elevating drive portion 1522a that moves the moving and locking portion 1521. In the present embodiment, the elevating mechanism is adopted as a movement mechanism for moving the tilting movable body 1514a, but for example, a movement mechanism capable of reciprocally tilting the tilting movable body 1514a, such as a swing mechanism and a cam mechanism, may be adopted.

The movement support base 1511 is supported on the base 1510 so as to be movable (rotatable) in a predetermined direction, and the tilting fixed body 1514b is disposed on the upper surface thereof. In the present embodiment, four tilting fixed bodies 1514b are arranged at predetermined intervals, specifically, at intervals of 90 degrees radially around the rotation axis of the movement support base 1511. The tilting fixed body 1514b movably (rotatably) supports the tilting movable body 1514a in a manner that one end portion and the other end portion of the tilting movable body 1514a supporting the holding portion 1512 have different heights.

Although details will be described later, the holding portion 1512 is configured to be able to hold the plate PL and is attached to the upper portion of the tilting movable body 1514a. In the present embodiment, four holding portions 1512 are provided, but the holding portion 1512 may be singular or plural. These four holding portions 1512 are arranged and moved at predetermined intervals around a movement (rotation) axis 1511C extending in the vertical direction of the movement (rotation) support base 1511.

Each of holding and locking portions 1513 is provided in each of the four holding portions 1512, and functions as a fall prevention member that locks the plate PL in a manner that the plate PL held by the holding portion 1512 does not fall. The holding and locking portion 1513 is provided on the engaging portion 1515 side of the tilting movable body 1514a.

Each of the engaging portions 1515 is provided in each of the four holding portions 1512. The engaging portion 1515 is a member formed in a substantially C-shape with one open side below the holding portion 1512, and is provided in a posture in which the open side faces radially outward of the base 1510.

The moving and locking portion 1521 is a member with an inverted L-shape in side view, and includes a pair of left and right plate portions 1521a and 1521b extending radially inward of the base 1510 from the upper end of a main body portion 1521mb. A fixed shaft 1521f into which a roller 1521r is fitted is provided between the plate portions 1521a and 1521b. The roller 1521r is rotatably provided with respect to the fixed shaft 1521f. The roller 1521r is then engaged with one of the four engaging portions 1515 at a predetermined position. Specifically, when the movement support base 1511 rotates and the engaging portion 1515 is horizontally moved, the moving and locking portion is fitted into the engaging portion in a manner that the open portion of the engaging portion 1515 houses (sandwiches) the moving and locking portion 1521. As a result, the moving and locking portion 1521 (the roller 1521r) and the engaging portion 1515 are engaged with each other, and the holding portion 1512 is tiltably supported, although details will be described later. Furthermore, the elevating drive portion 1522a is provided to be connected to the main body portion 1521mb of the moving and locking portion 1521.

Here, as described above, the holding portion 1512 is rotatably supported by the tilting movable body 1514a and the tilting fixed body 1514b. For this reason, by raising and lowering (moving up and down) the elevating drive portion 1522a in a state where the moving and locking portion 1521 and the engaging portion 1515 are engaged with each other, the tilting movable body 1514a is rotated with respect to the tilting fixed body 1514b and thus, the holding portion 1512 is tilted. In other words, among the four holding portions 1512, only the holding portion 1512 engaged with the moving and locking portion 1521 can be tilted by the elevating drive portion 1522a.

Note that, although the mode in which the engaging portion 1515 houses the moving and locking portion 1521 has been exemplified here, as another embodiment, the moving and locking portion 1521 and the engaging portion 1515 may be configured in a manner that their actions are opposite to each other. That is, the moving and locking portion 1521 may include a pair of upper and lower plate portions extending radially inward of the base 1510 from the upper end of the main body portion 1521mb, and a roller fitted between the pair of upper and lower plate portions may be provided on the engaging portion 1515 side.

To sum up the moving unit 151 and the tilting mechanism 152, when one of the four holding portions 1512 moves to the providing position P10 by the rotation of the rotation support base 1511, the engaging portion 1515 corresponding to the holding portion 1512 and the locking portion 1521 are engaged with each other. In this state, by the moving and locking portion 1521 rising and lowering, the holding portion 1512 rotates, that is, the holding portion 1512 and the plate PL held by the holding portion 1512 can be tilted. With such a configuration, the posture of the plate PL can be changed to, for example, a horizontal posture or an inclined posture.

The moving unit 151 described above can stop the holding portion 1512 and the plate PL held by the holding portion 1512 in at least three regions/positions. Firstly, the moving unit 151 stops the holding portion 1512 in a region where the plate PL is received from the pre-processing unit 11 and held by the holding portion 1512. Secondly, the moving unit 151 stops the holding portion 1512 and the plate PL held by the holding portion 1512 in a region where the worker provides the observation object on the plate PL. Furthermore, third, the moving unit 151 stops the holding portion 1512 and the plate PL held by the holding portion 1512 in a region where the plate PL to which the observation object is provided is taken out of the holding portion 1512 by the transfer unit 155 to be described later as an observation specimen. Here, a rotation drive mechanism is built in the base 1510, and the control unit 172 intermittently drives the rotation support base 1511 in a manner that at least one of the four holding portions 1512 is located in any one of the three regions described above. Details thereof will be described later.

The moving unit 151 may be expressed as a transport unit, a transfer unit, or the like from the viewpoint of sequentially moving the plate PL held by the holding portion 1512 to a predetermined position. Furthermore, the tilting mechanism 152 may be expressed as a posture changing unit, a posture adjusting unit, or the like from the viewpoint of changing the posture of the plate PL.

The liquid supply unit 153 includes a nozzle 1531 capable of discharging liquid, and a movement mechanism 154 that moves the nozzle 1531 between a liquid supply position and a standby position. Furthermore, the liquid supply unit 153 includes a supply mechanism (a pump or the like) (not illustrated) for sucking liquid from the liquid tank 1931 and discharging the liquid from the nozzle 1531. As a result, the liquid supply unit 153 can move the nozzle 1531 to the liquid supply position and supply the liquid onto the plate PL held by the holding portion 1512. Although details will be described later, a liquid pool can be formed on the plate PL.

The movement mechanism 154 is a slide mechanism in the present embodiment, and can move the liquid supply unit 153 in directions of arrows in the drawing. In the present embodiment, the movement mechanism 154 moves the liquid supply unit 153 between the position (the liquid supply position) for supplying liquid onto the plate PL and the standby position also referred to as a home position or the like. For example, the movement mechanism 154 causes the liquid supply unit 153 to stand by at the standby position while liquid supply is not performed, and moves the liquid supply unit 153 to the liquid supply position so that the nozzle 1531 is located on the plate PL when liquid supply is performed.

In the present embodiment, the transfer unit 155 is a manipulator capable of gripping the plate PL, and although details will be described later, the transfer unit 155 receives the plate PL to which the observation object is provided from the holding portion 1512 as the observation specimen and transfers the plate PL to the post-processing unit 12.

Note that, as illustrated in FIG. 5, the specimen preparation device 1 further includes a storage tank 171. The excess liquid or the dripped liquid supplied by the liquid supply unit 153 is guided to the storage tank 171 and stored in the storage tank 171.

### Regarding Work Flow in Specimen Preparation Device

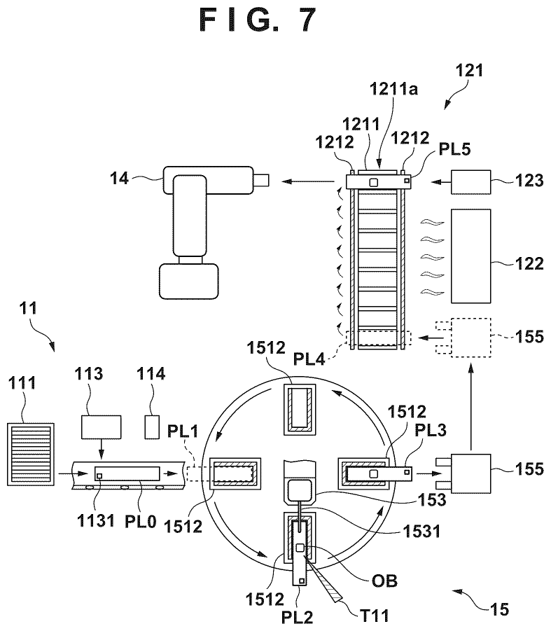

FIG. 7 is a schematic diagram for explaining work contents in the pre-processing unit 11, work contents in the unit 15, and work contents in the post-processing unit 12.

The pre-processing unit 11 includes a plate storage unit 111, a transport unit 112, a printing unit 113, and a reading unit 114. The plate storage unit 111 is a magazine (may be expressed as a cartridge, a cassette, or the like) that stores the plate PL before the observation object is provided, that is, a cleaned or unused plate PL to be used for preparing the observation specimen. The plate storage unit 111 stores a plurality of plates PL, and can sequentially feed the plurality of plates PL to the transport unit 112. In the case of the present embodiment, the plurality of plates PL are stacked and stored in the plate storage unit 111. The transport unit 112 is a transport belt in the present embodiment, and transports the plates PL fed from the plate storage unit 111 one by one toward the unit 15.

In the present embodiment, the printing unit 113 is an inkjet recording head, performs printing on the plate PL being transported by the transport unit 112, and provides, for example, predetermined identification information 1131. For example, a two-dimensional code is used as the identification information 1131, but alternatively and incidentally, a letter, a number, a symbol, a figure, or the like may be used.

The reading unit 114 can read the identification information 1131 provided to the plate PL, and can also output its result to the computer 95. The computer 95 can also cause the display terminal 96 to display contents indicating the identification information 1131. As a result, it is possible to associate the identification information 1131 with the observation object (the information of the observation object) provided to the plate PL to which the identification information 1131 is attached, and to manage these pieces of information.

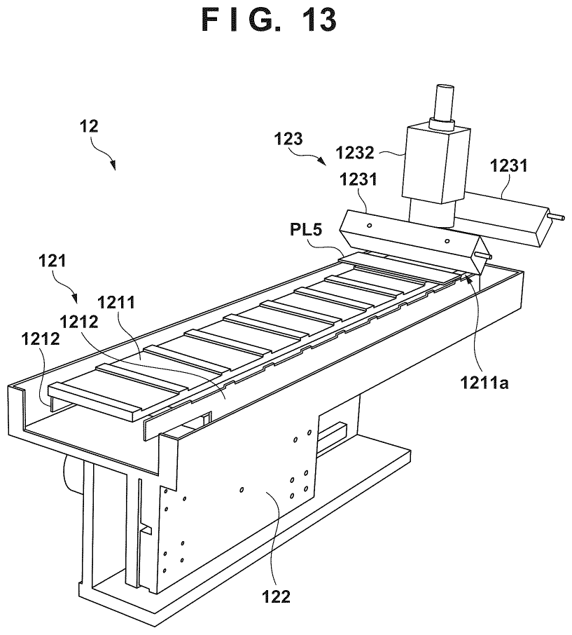

As illustrated in detail in FIG. 13, the post-processing unit 12 includes a transfer unit 121, the heating unit 122, and a confirmation unit 123. The transfer unit 121 is a walking beam transfer device in the present embodiment, and includes a specimen placement portion 1211 and a specimen transfer mechanism 1212. The specimen placement portion 1211 is an elongated plate member on which a plurality of observation specimens can be placed one by one. The specimen placement portion 1211 may be simply expressed as a placement portion. In addition, the confirmation unit 123 to be described later is disposed at a transfer terminal portion 1211a of the specimen placement portion 1211, and the state of the observation specimen transferred to the transfer terminal portion 1211a is confirmed.

The specimen transfer mechanism 1212 includes a pair of beam members arranged on both sides of the specimen placement portion 1211 and a drive mechanism for driving the beam members. By driving with the drive mechanism, the pair of beam members simultaneously moves up and down and horizontally in parallel. Specifically, the pair of beam members is continuously operated in the order of rising, movement in one transport direction (a feeding operation), lowering, and movement in the other transport direction (a returning operation), so that the observation specimen on the specimen placement portion 1211 is intermittently transferred in one direction. The specimen transfer mechanism 1212 may be simply expressed as a transfer mechanism, or may be expressed as a specimen transport mechanism (or simply a transport mechanism) or the like.

The heating unit 122 is installed below the transfer unit 121, and heats the observation specimen being transferred by the specimen transfer mechanism 1212 in a state of being placed on the specimen placement portion 1211. As a result, the observation object on the plate PL is extended. The heating unit 122 may be expressed as a temperature processing unit or the like, or may be expressed as a temperature processing unit, an observation object extending unit, or the like from the similar viewpoint.

The confirmation unit 123 confirms the processing state of the observation specimen heated by the heating unit 122. In this embodiment, the confirmation unit 123 includes an illumination device 1231 and an image capturing device 1232. A known lamp body including an LED or the like as a light source can be used for the illumination device 1231. A known camera including a CCD/CMOS image sensor can be used for the image capturing device 1232. The confirmation unit 123 captures the observation specimen by the image capturing device 1232 while irradiating the observation specimen with light by the illumination device 1231, records the observation specimen as image information, and associates the image information with the identification information 1131. In addition, the confirmation unit 123 can confirm the processing state of the observation specimen and perform predetermined determination, and can also output results of confirmation and determination to the computer 95. As a result, the observation object provided on the plate PL can be appropriately managed by the identification information 1131 attached to the plate PL together with the information indicating the results of the confirmation and the determination. The computer 95 can also cause the display terminal 96 to display information indicating whether or not the observation specimen is appropriately prepared. As another embodiment, the confirmation and determination may be performed by the computer 95.

To sum up the work contents in the pre-processing unit 11, the unit 15, and the post-processing unit 12 with reference to FIG. 7 again, the identification information 1131 is provided to the plate PL transported toward the unit 15 in the pre-processing unit 11 (illustrated as a “plate PL0” for distinction). The unit 15 receives the plate PL from the pre-processing unit 11 (illustrated as a “plate PL1” for distinction). Thereafter, the unit 15 moves the plate PL received from the pre-processing unit 11 to a position where the worker provides (places) the observation object (referred to as an observation object OB) (illustrated as a “plate PL2” for distinction).

Although details will be described later, liquid is supplied by the liquid supply unit 153 onto the plate PL, and a liquid pool is formed. The worker can place the observation object OB in the liquid pool on the plate PL using a tool T11 such as tweezers. Thereafter, the tilting mechanism 152 tilts the plate PL to remove the liquid pool from the plate PL. Note that, as the liquid, a solution or a chemical liquid having substantially no chemical influence on the observation object OB can be used, and while pure water is used in the present embodiment, physiological saline or the like may be used as another embodiment.

Thereafter, the unit 15 moves the plate PL to which the observation object OB is provided to a position accessible by the transfer unit 155 (illustrated as a “plate PL3” for distinction). The transfer unit 155 then takes out the plate PL to which the observation object OB is provided from the unit 15 as an observation specimen, and transfers the plate PL to the transfer unit 121 (illustrated as a “plate PL4” for distinction). Thereafter, the plate PL is transferred in a predetermined direction by the transfer unit 121 and is subjected to heating treatment by the heating unit 122, so that the observation object on the plate PL is extended. At the transfer terminal portion of the transfer unit 121, the confirmation unit 123 confirms whether or not the observation specimen is appropriately prepared (illustrated as a “plate PL5” for distinction). The transfer unit 14 takes out the plate PL and the observation object OB on the plate PL from the transfer unit 121 as an observation specimen and stores the observation specimen in the specimen storage unit 13.

Note that the timing of driving the unit 15 (for example, the timing of moving the plate PL) can be determined by the worker pressing the input device 94 (see FIGS. 1 to 2) connected to the control unit 172 with his/her foot. For example, after the plate PL from the pre-processing unit 11 is moved to a predetermined position by the unit 15, the worker may provide the observation object OB onto the plate PL and then press the input device 94.

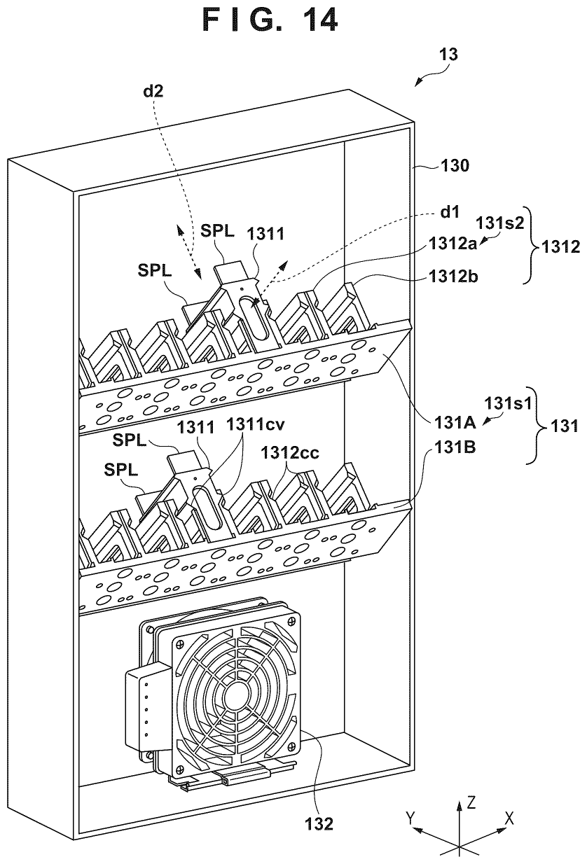

FIG. 14 is a perspective view illustrating a configuration example of the specimen storage unit 13. The specimen storage unit 13 includes a frame member 130, an upper plate member 131A, a lower plate member 131B, and an atmosphere adjustment unit 132. The plate members 131A and 131B are extended between the frame members 130 in a state of being inclined at a predetermined angle, and a two-stage rack 131 is formed by the plate members 131A and 131B. The plate members 131A and 131B include a plurality of housing portions 1312 at predetermined positions.

Each of the housing portions 1312 includes a pair of guide members 1312a and 1312b provided at a predetermined interval, and allows a case 1311 to be placed and taken out in a first inclination direction d1. Such a pair of guide members 1312a and 1312b is set as a set of housing portions 1312, and a plurality of sets of housing portions 1312 are provided on the individual plate members 131A and 131B. With such a configuration, the case 1311 is placed in any one of the housing portions 1312 in a posture inclined in the first inclination direction d1.

On the other hand, the transfer unit 14 can house the observation specimen SPL in the case 1311 inclined in the first inclination direction d1 and placed in the housing portion 1312 from a second inclination direction d2 intersecting with the first inclination direction d1, and can efficiently store the observation specimen SPL in the case 1311. In addition, since the inclination direction of placing the case 1311 in the housing portion 1312 and taking out the case 1311 from the housing portion 1312 is set as the first inclination direction d1, the worker can easily and efficiently handle the case 1311.

That is, the rack 131 is configured in a manner that the case 1311 can be inserted and removed in the first inclination direction d1, and the case 1311 is configured in a manner that the observation specimen SPL can be inserted and removed in the second inclination direction d2 in a state of being held by the rack 131. As illustrated in FIG. 14, the first inclination direction d1 is a direction obliquely upward and inward and outward of the specimen storage unit 13, and the second inclination direction d2 is a direction obliquely downward and inward and outward of the specimen storage unit 13.

In such a configuration, the plate members 131A and 131B function as first defining portions 131s1 for defining the position of each inserted case 1311 in the direction d1. In addition, the guide members 1312a and 1312b function as second defining portions 131s2 for defining the position of each inserted case 1311 in the left-right direction.

Here, in the second defining portion 131s2, the guide members 1312a and 1312b each has a recessed or valley shape as an engaged portion 1312cc. A protruding or mountain-shaped engaging portion 1311cv is formed on both side surfaces of the case 1311 so as to correspond to the engaged portion 1312cc. The engaging portion 1311cv and the engaged portion 1312cc guide the sliding of the case 1311 in the first inclination direction d1. From this viewpoint, the second defining portion 131s2 also contributes to defining the position of each inserted case 1311 in the direction d2.

Note that the engaging portion 1311cv and the engaged portion 1312cc can be formed to be able to guide the sliding of the case 1311, and the engaging portion 1311cv may be formed in a recessed or valley shape, and the engaged portion 1312cc may be formed in a protruding or mountain shape.

Here, two plate members, that is, the plate members 131A and 131B are exemplified, but the number of plate members (that is, the number of racks) is not limited thereto. In addition, one or more cases 1311 that can house a predetermined number of observation specimens SPL as one set can be housed in the housing portion 1312 in each of the plate members 131A and 131B. As a result, it is easy for the worker to manage the plurality of observation specimens SPL.

With such a configuration, the plurality of cases 1311 can be placed side by side in the left-right direction and the vertical direction (In the present embodiment, a total of 12 cases including six cases 1311 in the left-right direction and two cases 1311 in the vertical direction can be arranged.). The rack 131 may be expressed as a case placement portion, and the frame member 130 and the plate members 131A and 131B may be integrated with the case placement portion.

In the present embodiment, the atmosphere adjustment unit 132 is a blower installed below the plate members 131A and 131B, and adjusts the atmosphere of the specimen storage unit 13 to a desired environment. For example, the atmosphere adjustment unit 132 includes an environment adjustment unit (not illustrated) capable of maintaining the atmosphere of the specimen storage unit 13 at a desired temperature and/or at a desired humidity. The atmosphere adjustment unit 132 may be expressed as an environment maintenance unit, an environment management unit, an air conditioning unit, or the like.

Note that the atmosphere adjustment unit 132 may be omitted in a case where the environment itself in which the specimen preparation device 1 (or the specimen preparation system SY) is installed can be maintained under a predetermined condition.

### Regarding Attachment Members of Housing

Referring again to FIGS. 3 to 4, the opening and closing members 191, 192, 194, and 195, the plate member 196, and the window member 197 are attached to the housing 100 so that the worker can visually recognize the inside of the housing 100 and/or the worker can access the inside of the housing 100 as necessary. These members are partitioning members that partition the inside and outside of the housing 100 together with the housing 100. Note that a notification lamp 182 is provided on the upper portion of the housing 100, and when access to the inside of the housing 100 is required, the notification lamp 182 is turned on or blinked to notify the worker.

The opening and closing member 191 is a light transmissive cover provided on the upper portion of the front wall portion F11 in an openable and closable manner, and is a rotary door in the present embodiment. The worker can access the pre-processing unit 11 by opening the opening and closing member 191, and for example, the worker can replenish the plate storage unit 111 with the plate PL or replace the plate storage unit 111 with a new one.

The opening and closing member 192 is a light transmissive cover provided on the front wall portion F11 in an openable and closable manner. The worker can access the specimen storage unit 13 by opening the opening and closing member 192, and for example, can take out the observation specimen SPL by taking out the case 1311 from the specimen storage unit 13.

The opening and closing member 194 is a door member provided on the side wall portion F12 in an openable and closable manner, and is a door member including a window member. The worker can access each part of the post-processing unit 12 by opening the opening and closing member 194, and can remove, for example, the observation specimen determined to be not appropriately prepared by the confirmation unit 123.

The opening and closing member 195 is a door member provided on the side wall portion F14 in an openable and closable manner and is a door member including a window member, and is a rotary door in the present embodiment. The opening and closing member 195 is provided on the side wall portion F1, for example, in a size enclosing the operation range of the transfer unit 14, and the maintenance of the inside of the housing 100 can be easily performed by the worker opening the opening and closing member 195. The opening and closing member 195 may be expressed as a maintenance door or the like.

By each of the opening and closing members 191, 192, 194, and 195 being opened and closed, the opening communicating the inside and the outside of the specimen preparation device 1 can be brought into an open state or a closed state. For example, by opening or closing the opening and closing member 192, an opening OP13 communicating the inside and the outside of the specimen storage is brought into the open state or the closed state.

The window member 197 is a light transmissive plate member provided on the back wall portion F15. The worker can visually recognize the state in the housing 100 also from the back side of the device 1.

In the present embodiment, the plate member 196 is a light transmissive plate member fixed to the upper portion of the front wall portion F11. The plate member 196 exposes a part of the unit 15 described above (see FIGS. 6, 9, and 7) to the outside of the housing 100 as a region (a providing region) that can be accessed by the worker to provide the observation object OB. The providing position P10 described with reference to FIG. 3 is included in this providing region.

As can be seen from FIG. 3, a work assist portion P11 on which the worker can place a part of the arm or hand is provided in the vicinity of the providing position P10. As a result, when providing (placing) the observation object OB on the plate PL at the providing position P10, the worker can place (bring) and fix (stabilize) a part of the arm or hand of the worker (into contact with) on the work assist portion P11, and the worker can provide the observation object OB on the plate PL in a stable posture. Note that, in the present embodiment, the work assist portion P11 is the upper side portion of the corner side wall portion F13, but a dedicated member such as an armrest member may be installed and used.

Here, in the unit 15, the rotation support base 1511 rotates, so that one of the four holding portions 1512 moves to the providing position P10. On the other hand, the other three holding portions 1512 are located in the housing 100. A predetermined gap is formed below the plate member 196 (between the plate member 196 and the upper surface of the rotation support base 1511 in the present embodiment), and the individual holding portions 1512 pass through the gap as the rotation support base 1511 rotates.

### Regarding Installation Mode of Observation Object Provision Unit and the Like

As can be seen from FIG. 3, the observation object provision unit 15 and the providing position P10 (a part of the unit 15 exposed by the plate member 196) are provided close to the corner portion of the housing 100 (on the corner side wall portion F13 side), and are set as the providing region. Here, being close to the corner portion means being closer to the corner portion than other corner portions. As a result, the worker can efficiently perform work on the specimen preparation device 1 and the working table 91.

In the present embodiment, the distance between the observation object creation device 92 and (the providing position P10 of) the unit 15 is short. For this reason, the work of taking out the observation object OB from the device 92 and transferring the observation object OB to the unit 15 can be efficiently performed. The distance (height difference) between the unit 15 and the device 92 in the vertical direction is preferably short (for example, 50 cm or less, preferably 30 cm or less, more preferably 20 cm or less), and both of the unit 15 and the device 92 are located above the waist and below (lower than) the shoulder of the worker, so that the burden on the body of the worker is reduced, and the work can be performed more efficiently. Note that the height of the specimen preparation device 1 and/or the working table 91 may be adjusted so as to satisfy such a condition.

Furthermore, the housing 100 of the specimen preparation device 1 has a chamfered shape at the corner portion (including the corner side wall portion F13), thereby making it possible to reduce the interference of the worker's legs with the housing 100. In order to appropriately implement this, the width of the corner side wall portion F13 in the horizontal direction may be, for example, about 10 cm, preferably about 15 cm or more. Moreover, the first angle (the inner angle) between the front wall portion F11 and the corner side wall portion F13 and the second angle between the side wall portion F12 and the corner side wall portion F13 may be, for example, about 110 to 160 [degrees], and preferably about 130 to 140 [degrees].

Furthermore, as can be seen from FIG. 3, in the present embodiment, the corner portion of the housing 100 has a chamfered shape in which the corner side wall portion F13 is disposed over the entire region from the upper end portion to the lower end portion. However, as another embodiment, the chamfered shape may be partially provided (for example, at the upper end portion and the intermediate portion), and can be provided at a necessary position.

### Regarding Configuration of Holding Portion

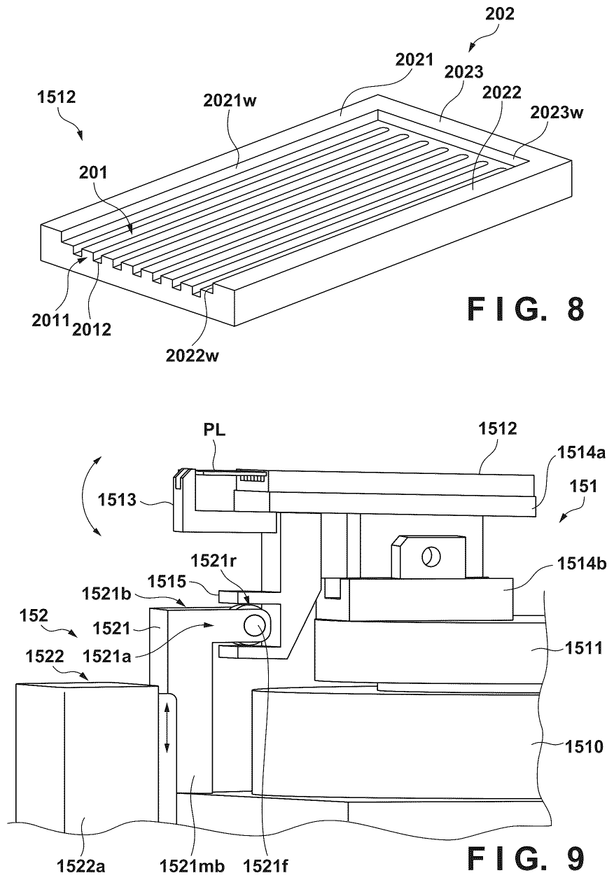

FIG. 8 is a perspective view illustrating the structure of the holding portion 1512. The holding portion 1512 includes a placement portion 201 and a wall portion 202. The placement portion 201 is a portion that forms a placement surface for placing the plate PL, and is preferably formed of a material that prevents slipping of the plate PL and has a shape (in this case, an elongated shape) corresponding to the size of the plate PL. The placement surface has an uneven shape, and in the present embodiment, an abutting portion (a protruding portion) 2011 that abuts on the back surface of the plate PL and a non-abutting portion (a recessed portion) 2012 that does not abut on the back surface of the plate PL are alternately provided in a lateral direction and in a groove shape along the longitudinal direction. For example, in a case where an excessive liquid is supplied onto the plate PL, an excessive amount of the liquid enters the non-abutting portion 2012, and adhesion that can be caused by surface tension of the liquid entering between the back surface of the plate PL and the abutting portion (the protruding portion) 2011 can be reduced.

The wall portion 202 is provided on three side portions of the placement portion 201, and includes side wall portions 2021 and 2022 and an end side wall portion 2023 in the present embodiment. The side wall portions 2021 and 2022 are provided along the longitudinal direction at both end portions in the lateral direction of the placement portion 201. The end side wall portion 2023 is provided along the lateral direction at one end portion in the longitudinal direction of the placement portion 201. In the present embodiment, the wall portions 2021 to 2023 are connected to each other, that is, the wall portion 202 is integrally molded in a substantially U-shape in a manner that the three side portions of the placement portion 201 are closed and the remaining one side portion is opened. Furthermore, the side wall portions 2021 and 2022 and the end side wall portion 2023 include wall surfaces extending upward from the placement surface of the abutting portion 2011 at a height equal to or larger than the thickness of the plate PL, that is, the inner peripheral surface is formed by a side wall surface 2021w included in the side wall portion 2021, a side wall surface 2022w included in the side wall portion 2022, and a side wall surface 2023w included in the end side wall portion 2023. With such a configuration, the wall portion 202 surrounds three sides of the plate PL in a case where the plate PL is placed on the placement portion 201. The wall portion 202 may be expressed as a frame portion or the like.

The wall portion 202 includes a lyophobic portion with lyophobic properties (a liquid-repellent portion with liquid repellency) at least on the surface. That is, at least the surface of the wall portion 202 is made of a lyophobic material that is resistant to wetting by liquids, or is treated with a material with lyophobic properties. For example, in a case where water is used as the liquid, a silicon resin, a fluororesin, or the like having hydrophobicity or water repellency is used. The lyophobic property is a relative property indicating a property with respect to a liquid on a certain upper surface, but typically, the lyophobic property can be determined on the basis of whether or not the contact angle of a droplet on the upper surface satisfies a predetermined condition. For example, when the contact angle of a droplet is θ_{w}, for example, in a case where 45°<θ_{w}, preferably 60°<θ_{w} is satisfied, the lyophobic property may be determined.

Note that, in the present embodiment, the placement portion 201 and the wall portion 202 are integrally molded, but as another embodiment, all or a part of the wall portion 202 may be configured as a separate member that can be attached to the placement portion 201. In addition, a member subjected to lyophobic treatment may be disposed on the upper portion of the wall portion 202.

With such a configuration, the holding portion 1512 appropriately holds the plate PL placed on the placement portion 201 while surrounding the plate PL by the wall portion 202. The holding portion 1512 may be expressed as a plate placement member (or simply a placement member), a base plate, an observation specimen preparing jig, or the like. In a case where liquid is supplied onto the plate PL by the liquid supply unit 153, the liquid stays on the plate PL in a state of forming a liquid surface higher than the upper surface of the wall portion 202 by the lyophobic portion of the wall portion 202, so that a liquid pool is appropriately formed on the plate PL. In addition, in a case where the holding portion 1512 and the plate PL are tilted to the open side (the side on which the wall portion 202 is not provided, the side opposite to the end side wall portion 2023) of the wall portion 202 by the tilting mechanism 152, the liquid in the liquid pool flows toward the open side of the substantially U-shaped wall portion 202 and is discharged, and thus the liquid pool is removed from the plate PL.

### Regarding Mode of Providing Observation Object on Plate

FIG. 10 illustrates a top view of a configuration of the holding portion 1512 and a cross-sectional view taken along line dx1-dx1 illustrated at a substantially intermediate position of the top view (hereinafter, simply referred to as a “cross-sectional view”, and the same applies to other cross-sectional views in the present embodiment) side by side. A state S100 is illustrated as a top view and a cross-sectional view illustrating a state before the plate PL is disposed in the holding portion 1512 (a state of only the holding portion 1512). A state S101 is illustrated as a top view and a cross-sectional view illustrating a state after the plate PL is disposed in the holding portion 1512. In the present embodiment, the plate PL includes a placement portion 211 on which the observation object OB is to be placed and a frost portion 212 on which the identification information 1131 can be printed.

As described above, by tilting the plate PL by the tilting mechanism 152, the liquid in the liquid pool can be discharged (liquid discharge can be performed) from the open side of the substantially U-shaped wall portion 202, so that the liquid pool can be removed from the plate PL. That is, one end portion of the plate PL on the open side of the wall portion 202 corresponds to an end portion (liquid discharge downstream side end portion) on the downstream side in a liquid flowing direction (moving direction) when liquid is discharged, and the other end portion on the opposite side (the end side wall portion 2023 side) corresponds to an end portion (liquid discharge upstream side end portion) on the upstream side. From this viewpoint, the end portion of the holding portion 1512 on the open side of the wall portion 202 may be expressed as a liquid discharge portion or the like.

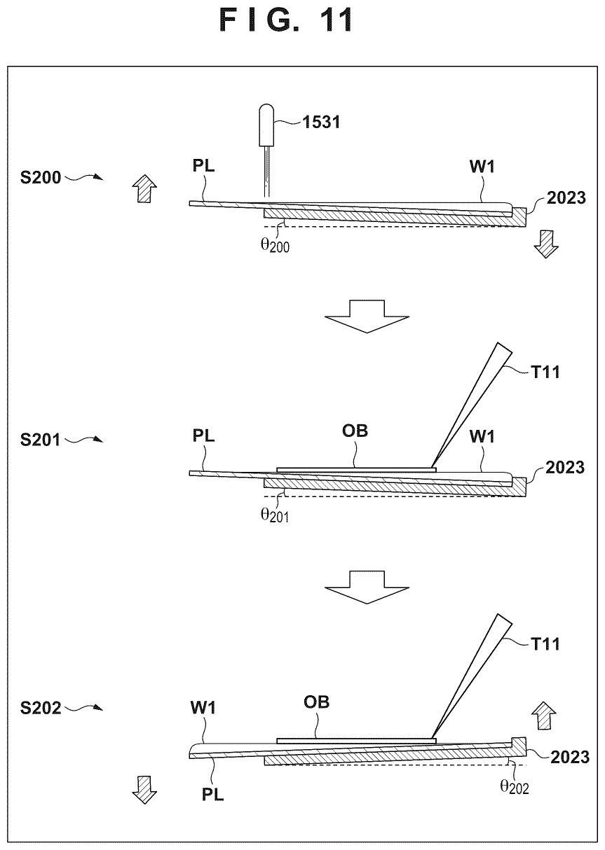

FIG. 11 is a cross-sectional view illustrating a state of preparing the observation specimen SPL in the unit 15 for each step. The method of preparing the observation specimen SPL is roughly divided into a step of forming the liquid pool W1 on the plate PL held by the holding portion 1512, a step of placing the observation object OB on the liquid pool W1, and a step of fixing the observation object OB to the plate PL while removing the liquid pool W1.

A state S200 is illustrated as a cross-sectional view illustrating a step of inclining the plate PL together with the holding portion 1512 and then supplying liquid onto the plate PL. First, the holding portion 1512 and the plate PL in the horizontal posture are inclined in a first direction indicated by arrows to be in a first inclined posture. As a result, the other end portion of the plate PL on the end side wall portion 2023 side is lower than the one end portion of the plate PL on the open side of the wall portion 202. The inclination angle (the angle formed by the surface (upper surface) of the plate 1 and the horizontal plane: θ₂₀₀) at this time may be, for example, about 0.5 to 5 [degrees], and is about 1 [degrees] in the present embodiment.

Next, the liquid is supplied onto the plate PL in the state S200 by the nozzle 1531 (of the liquid supply unit 153). As described above, the holding portion 1512 includes the lyophobic wall portion 202. For this reason, on the plate PL in an inclined posture at the inclination angle θ₂₀₀, the supplied liquid is blocked by the wall portion 202 and appropriately stays on the plate PL, so that the liquid pool W1 is formed on the plate PL. Specifically, the supplied liquid is repelled by the lyophobic effect of the wall portion 202 and stays on the plate PL, and the liquid pool W1 is formed in a manner that the surface (the surface on which the observation object OB is to be placed later) thereof is located above the upper surface of the wall portion 202. The depth (liquid depth) of the liquid in the liquid pool W1 becomes deeper on the other end portion side, which is the end side wall portion 2023 side, than on the one end portion side, which is the open side of the wall portion 202.

A state S201 is illustrated as a cross-sectional view illustrating a step of placing the observation object OB on the liquid pool W1. The worker places the observation object OB on the liquid pool W1 using the tool T11. As described above, the liquid depth of the liquid pool W1 becomes deeper on the other end portion side, which is the end side wall portion 2023 side, than on the one end portion side, which is the open side of the wall portion 202. Although details will be described later, at this stage, the worker preferably presses and holds the observation object OB against the liquid pool W1 by the tool T11 so that the position of the observation object OB does not change. Note that the inclination angle in the state S201 is illustrated as an inclination angle θ₂₀₁ (=θ₂₀₀).

A state S202 is illustrated as a cross-sectional view illustrating a step of inclining the plate PL in which the observation object OB is placed on the liquid pool W1 in a second direction opposite to that in the state S201 described above to be in a second inclined posture (illustrated as an inclination angle θ₂₀₂) and starting the discharge of the liquid in the liquid pool W1. As a result, the liquid in the liquid pool W1 is guided to the one end side, which is the open side of the wall portion 202.

Here, in the state S202, the liquid depth of the liquid pool W1 becomes shallower on the other end portion side, which is the end side wall portion 2023 side, than on the one end portion side, which is the open side of the wall portion 202. Since the observation object OB is placed so as to be close to the surface of the plate PL from at least the other end portion side, the observation object OB can directly contact the surface of the plate PL on the other end portion side.

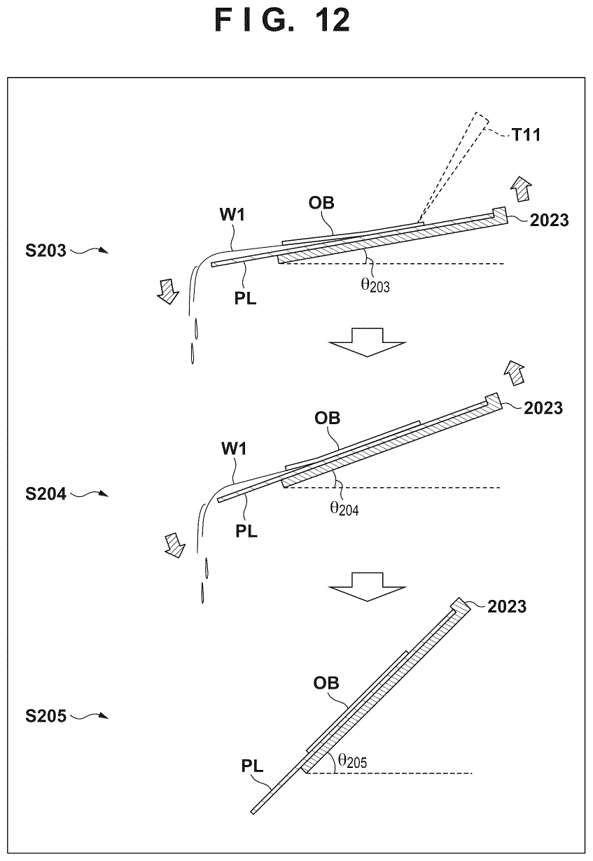

FIG. 12 is a cross-sectional view illustrating a step of further inclining the plate PL in the second direction to promote and complete the discharge of the liquid in the liquid pool W1 on the plate PL.

In a state S203, the inclination angle of the plate PL is further increased (the plate PL takes an inclined posture steeper than the second inclined posture), so that the plate is in a third inclined posture (illustrated as an inclination angle θ₂₀₃ (>θ₂₀₂)). In the state S203, as the liquid in the liquid pool W1 is discharged, the liquid level of the liquid decreases (the liquid moves to the open side of the wall portion 202). As a result, the observation object OB on the liquid pool W1 directly contacts the surface of the plate PL on the other end portion side (the end side wall portion 2023 side), and/or the contact area increases. On the other hand, on the one end portion side (the open side of the wall portion 202), the observation object OB is still located on the liquid pool W1.

Note that, in this state 203 (or the state 202 described above), since the observation object OB is partially fixed to the plate surface at least on the liquid discharge upstream side, the worker may separate the tool T11 from the observation object OB.

In a state S204, the inclination angle of the plate PL is further increased (the plate PL takes an inclined posture steeper than the third inclined posture), so that the plate is in a fourth inclined posture (illustrated as an inclination angle θ₂₀₄ (>θ₂₀₃)). In the state S204, the area in which the observation object OB on the liquid pool W1 is in contact with the surface of the plate PL is further increased. The observation object OB can thus be adhered to the surface of the plate PL without causing wrinkles, twists, and the like in the observation object OB.

In a state S205, the inclination angle of the plate PL is further increased (the plate takes an inclined posture steeper than the fourth inclined posture), so that the plate is in a fifth inclined posture (illustrated as an inclination angle θ₂₀₅ (>θ₂₀₄)). In the state S205, the discharge of the liquid in the liquid pool W1 is completed, and the entire observation object OB adheres to the surface of the plate PL, so that the observation specimen SPL is prepared. The inclination angle θ₂₀₅ is, for example, about 40 to 60 [degrees], and is about 55 [degrees] in the present embodiment.

In short, according to the steps of the states S200 to S205, as the liquid spreading on the surface of the plate PL is discharged (the liquid outflows from the space between the observation object OB and the surface of the plate PL), the observation object OB continuously adheres to the surface of the plate PL from the other end portion side (the end side wall portion 2023 side) toward the one end portion side (the open side of the wall portion 202). That is, after the observation object OB is partially brought into contact with the surface of the plate PL on the liquid discharge upstream side, the observation object OB is brought into contact with the surface of the plate PL in order from the liquid discharge upstream side to the liquid discharge downstream side. As a result, the observation object OB can be finally fixed to the surface of the plate PL. Therefore, according to the present embodiment, the observation object OB is in a state where wrinkles, twists, and the like are eliminated on the plate PL and in an easily observed state, and the observation specimen SPL can be appropriately prepared.

### Regarding Opening and Closing Member in Specimen Storage Unit

As described above, the transfer unit 14 transfers the observation specimen SPL from the transfer unit 121 to the specimen storage unit 13. Therefore, the case 1311 in which the observation specimen SPL is to be housed is required to be fixed at a predetermined position in the specimen storage unit 13.

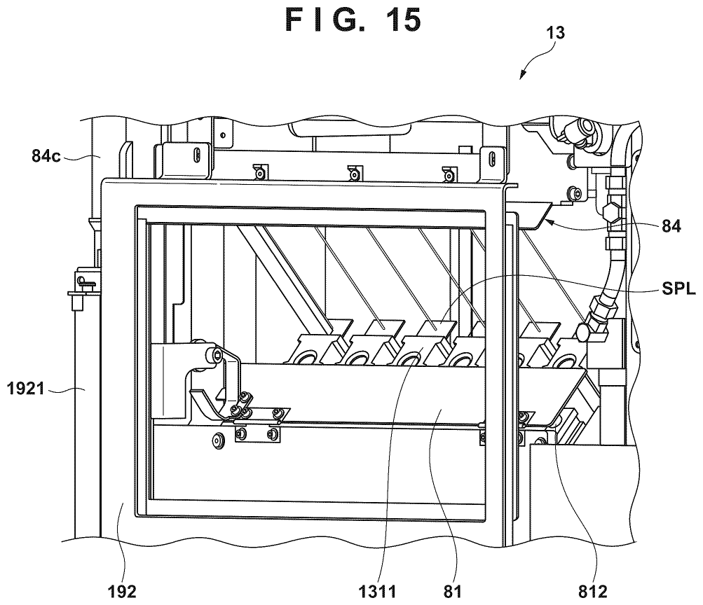

FIG. 15 is a perspective view illustrating an example of the configuration of the specimen storage unit 13 according to the present embodiment. As described above, the opening and closing member 192 may be regarded as a part of the specimen storage unit 13, and the specimen storage unit 13 may be expressed as the specimen storage 13. Here, the exterior panel of the housing 100 is not illustrated in order to facilitate understanding of the internal structure.

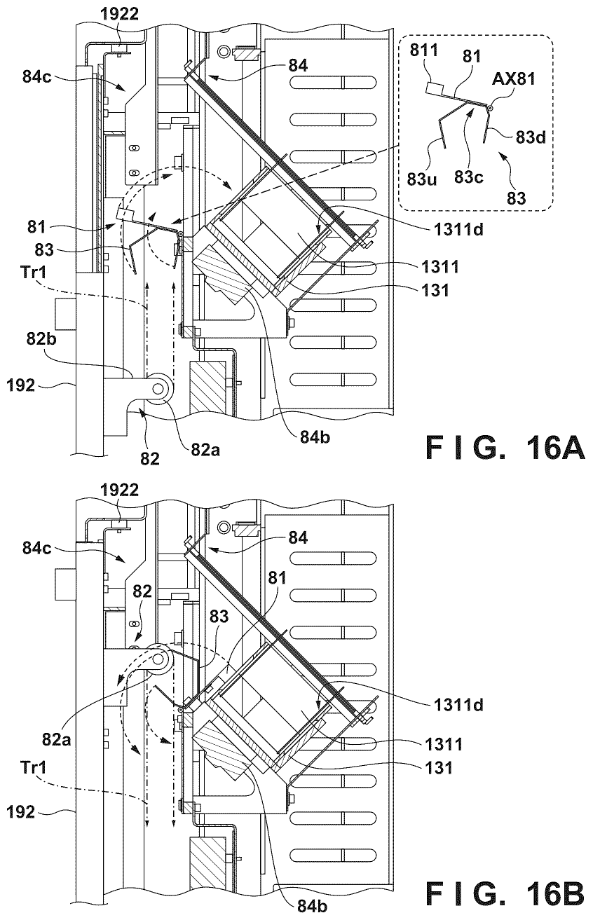

FIG. 16A is a schematic side view of the opening and closing member 192 in an open state, and FIG. 16B is a schematic side view of the opening and closing member 192 in a closed state.

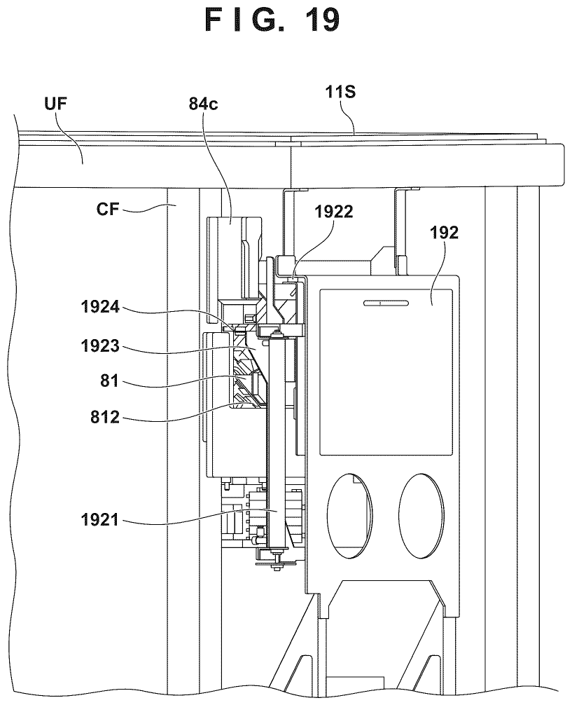

FIG. 19 is a perspective view of the opening and closing member 192 in the closed state, and illustrates a perspective view of the internal structure of the specimen storage unit 13.

The specimen storage unit 13 may further include an abutting member 81 capable of abutting on the case 1311. The abutting member 81 is rotatably fixed to the main body (here, a frame member or a base that supports the exterior panel of the housing 100 of the specimen preparation device 1, for example, the coupling support member CF or the like) of the specimen storage unit 13. The rotation shaft of the abutting member 81 is illustrated as a shaft AX81 in FIG. 16A. That is, the shaft AX81 functions as a rotation support portion that rotatably supports the abutting member 81, and is fixed to, for example, the rack 131.

Typically, a plate-like member can be used as the abutting member 81, but any configuration can be used as long as the abutting member 81 can contact the case 1311, and a contact portion 811 may be provided as in the present example, or the contact portion 811 may be omitted, and it is not limited to the present example. Since the case 1311 is pressed by abutment, the abutting member 81 may be expressed as a pressing member. The plate-like member used as the abutting member 81 has a predetermined length in the left-right direction in which the plurality of cases 1311 are arranged.

In a case where the rack 131 is made of metal or the like, the abutting member 81 may include a magnet incidentally. In this case, by the magnet attracting the rack 131, the abutting member 81 can fixedly abut on the rack 131 and maintain the pressing state. In the present embodiment, it is assumed that a magnet capable of implementing such a state is provided as a pressing member holding portion 812.

An engaging portion 82 is attached to the opening and closing member 192, and an engaged portion 83 is attached to the abutting member 81. The engaging portion 82 includes a roller 82a and a bracket 82b that rotatably supports the roller 82a. The roller 82a can be attached to the bracket 82b using a bolt, a nut, a spacer, or the like.

The engaged portion 83 includes a central portion 83c fixed to the abutting member 81, an end portion 83u extending from one side of the central portion 83c, and an end portion 83d extending from the other side of the central portion 83c. A C-shaped arm member is used as the engaged portion 83, and the shape connecting the central portion 83c, the end portion 83u, and the end portion 83d is illustrated as being bent in the present example. However, as another example, the shape may be curved. Furthermore, each of the end portion 83u and the end portion 83d extending from the central portion 83c can be rephrased as an arm portion, and the C-shaped arm member can also be expressed as a C-shaped member (a C-shaped member) including two arm portions.

In the open state of the opening and closing member 192 (the state of FIG. 16A), the opening and closing member 192 is at an open position, and the abutting member 81 is in a posture inclined outward (to the side in the direction of taking out the case 1311) in side view. In this state, the end portion 83u of the engaged portion 83 overlaps the roller 82a of the engaging portion 82 in the Z direction and is located outward of the end portion 83d. Therefore, in a case where the opening and closing member 192 slides upward, the roller 82a moves upward accordingly to engage with the end portion 83u, and rotates the abutting member 81 inward. In this manner, the opening and closing member 192 is brought into the closed state, and during that time, the abutting member 81 takes a posture inclined inward (see FIG. 16B). In this case, the end portion 83u functions as a first engaged portion.

According to this configuration, in the open state of the opening and closing member 192, the inside of the C-shaped arm member as the engaged portion 83 has a shape in which the receiving port for receiving the roller 82a from below faces downward.

In the closed state of the opening and closing member 192 (the state of FIG. 16B), the opening and closing member 192 is at a closed position, and the abutting member 81 takes the posture inclined inward as described above. In this state, the end portion 83d of the engaged portion 83 overlaps the roller 82a of the engaging portion 82 in the Z direction and is located outward of the end portion 83u. Therefore, in a case where the opening and closing member 192 slides downward, the roller 82a moves downward accordingly to engage with the end portion 83d, and rotates the abutting member 81 outward as illustrated by a broken line arrow. In this manner, the opening and closing member 192 is brought into the open state, and during that time, the abutting member 81 takes a posture inclined outward (see FIG. 16A). In this case, the end portion 83d functions as a second engaged portion.

According to this configuration, in the closed state of the opening and closing member 192, the inside of the C-shaped arm member as the engaged portion 83 has a shape in which the receiving port for receiving the roller 82a from above faces upward.

From the above viewpoint, the end portion 83u may be expressed as an upper engaged portion, the end portion 83d may be expressed as a lower engaged portion, and the central portion 83c may be expressed as a coupling portion or a connecting portion that couples or connects the upper and lower engaged portions.

The positional relationship described above is as follows from the viewpoint of a movement trajectory Tr drawn by the roller 82a by opening and closing the opening and closing member 192. That is, when the opening and closing member 192 is located at the open position, the end portion 83u is located within the movement trajectory Tr, and the end portion 83d is located outside the movement trajectory Tr (see FIG. 16A). On the other hand, when the opening and closing member 192 is located at the closed position, the end portion 83d is located within the movement trajectory Tr (see FIG. 16B).

The main body of the specimen storage unit 13 may include a sensor for detecting the open and closed states of the opening and closing member 192, for example, a solenoid switch, and may further include an electromagnetic lock for locking the closed state of the opening and closing member 192.

As an example, as illustrated in FIG. 19, a sensor 84c that detects the position of the opening and closing member 192 may be provided (Details of the operation of the sensor 84c will be described later.). The sensor 84c can detect the position (the open state or closed state) of the opening and closing member 192 by insertion of an insertion member 1924 integrated with the opening and closing member 192 via a flange 1923. The electromagnetic lock may be installed to fix the opening and closing member 192 at the closed position by locking the insertion member 1924 within the sensor 84c.

Referring again to FIGS. 16A and 16B, trajectories of the contact portion 811, the end portion 83u, and the end portion 83d when the abutting member 81 rotates are illustrated by broken line arrows. The angle between the central portion 83c and the end portion 83u and the angle between the central portion 83c and the end portion 83d can be set in a manner that the abutting member 81 appropriately rotates when the opening and closing member 192 moves up and down.

With such a configuration, the abutting member 81 abuts on the case 1311 in a case where the opening and closing member 192 is in the closed state, and is separated from the case 1311 in a case where the opening and closing member 192 is in the open state. For example, the worker can take out the observation specimen SPL from the specimen storage unit 13 together with the case 1311 by bringing the opening and closing member 192 into the open state and separating the abutting member 81 from the case 1311. Thereafter, the worker can install a new case 1311 (alternatively, the case 1311 in which the observation specimen SPL is collected) in the specimen storage unit 13 and bring the opening and closing member 192 into the closed state again. When the opening and closing member 192 is in the closed state, the newly installed case 1311 is pressed by the abutment of the abutting member 81 and fixed at a predetermined position (a predetermined height). More specifically, the abutting member 81 functions to retain (or hold) the case 1311 at the predetermined position by abutting against the case 1311, thereby preventing unintended movement of the case 1311 during specimen transfer operations. As a result, the transfer unit 14 can appropriately transfer the observation specimen SPL from the transfer unit 121 to the specimen storage unit 13, and for example, can house the observation specimen SPL at a desired position in the case 1311.

Note that the case 1311 may not be installed at a correct position with respect to the rack 131 due to, for example, the case 1311 being caught by the rack 131. In such a case, when the opening and closing member 192 shifts from the open state to the closed state, the abutting member 81 abuts on the case 1311 midway. In such a case, the opening and closing member 192 cannot shift to the closed state and is restricted midway.

As described above, the engaging portion 82 moves the abutting member 81 between the position where the abutting member 81 abuts on the case 1311 and the position where the abutting member 81 is separated from the case 1311 by the engagement with the engaged portion 83 as the opening and closing member 192 is opened and closed. From this viewpoint, the engaging portion 82 and the engaged portion 83 may be expressed as movement mechanisms.

The opening and closing mechanism of the opening and closing member 192 may be modified without departing from the gist thereof. For example, an air cylinder may be provided as a movement assist mechanism 1921 that assists the movement of the opening and closing member 192 in the vertical direction (see FIG. 15). Furthermore, a magnet may be provided as an opening and closing member holding portion 1922 for holding the opening and closing member 192 at the closed position (see FIG. 19).

Here, the single case 1311 has been described as an example, but the same applies to a case where two or more cases 1311 are provided. That is, any of the two or more cases 1311 can be fixed at a predetermined position by abutment of the abutting member 81 when the opening and closing member 192 is brought into the closed state. The predetermined position is a position where a bottom portion 1311d of the case 1311 abuts on the first defining portion 131s1 of the plate member 131A or 131B (see FIGS. 16A and 16B).

In the present example, since the number of the racks 131 is two (the configuration using two plate members, that is, the plate members 131A and 131B), two abutting members 81 can be provided, but the number of the racks 131 is not limited to the present example. For example, the number of the racks 131 may be one, or three or more. In a case where the plurality of abutting members 81 are provided (in a case where the number of the racks 131 is plural), the plurality of abutting members 81 sequentially rotate based on the vertical movement of the opening and closing member 192.

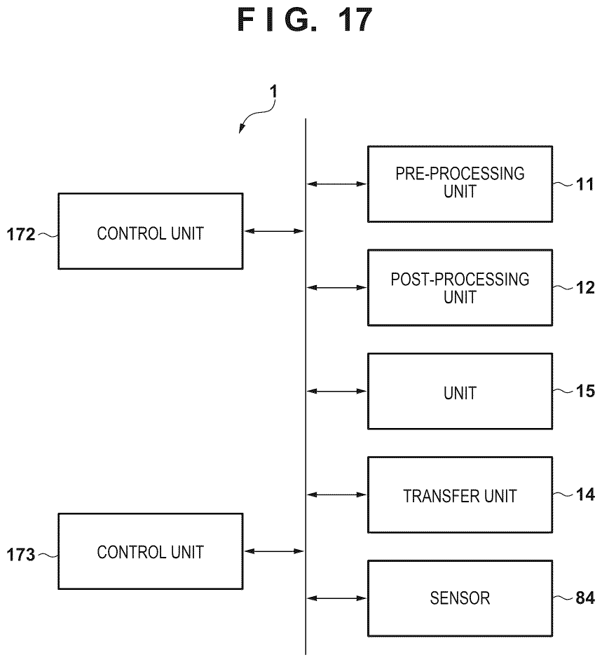

FIG. 17 is a diagram illustrating an example of a system configuration of the specimen preparation device 1. For example, the control unit 172 and/or 173 performs predetermined arithmetic processing on the basis of a control signal received from the outside of the specimen preparation device 1 (the input device 94 or the like), and performs specimen preparation on the basis of the result. For example, as described above, the control unit 172 executes drive control of the pre-processing unit 11, the unit 15, and the post-processing unit 12.

In addition, the specimen storage unit 13 further includes a sensor 84 capable of detecting the presence or absence of the observation specimen SPL held in the case 1311, and the control unit 173 can execute drive control of the transfer unit 14 on the basis of the detection result of the sensor 84. An infrared sensor or the like can be typically used as the sensor 84.

For example, in a case where one or more observation specimens SPL remain in the case 1311 newly installed in the specimen storage unit 13, a signal indicating the fact is output from the sensor 84 to the control unit 173. On the basis of the signal, the control unit 173 controls the transfer unit 14 in a manner that the case 1311 in which one or more observation specimens SPL remain is not transferred. As a result, it is possible to prevent a situation in which irrelevant observation specimens SPL are mixed in the same case 1311 (for example, a situation in which an old observation specimen SPL and a new observation specimen SPL are mixed), and it is possible to appropriately manage the observation specimens SPL in units of cases 1311.

According to such a configuration, for example, the worker can access the case 1311 in which one or more observation specimens SPL remain by bringing the opening and closing member 192 into the open state, and collect the remaining observation specimen SPL or replace the case 1311 with another case 1311.

Alternatively and incidentally, the detection result of the sensor 84 may be output to the display terminal 96 and/or the operation display panel 181 as a state display unit.

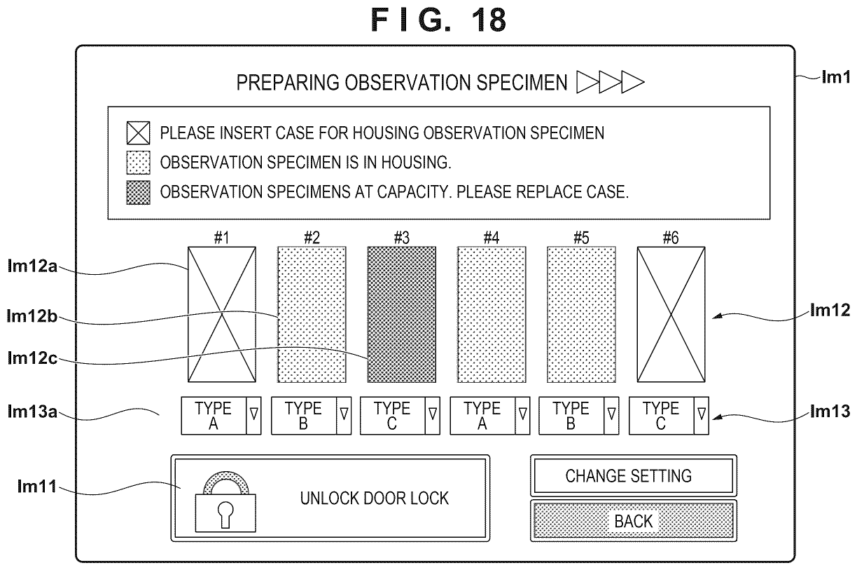

FIG. 18 illustrates an example of an image Im1 displayed on the display terminal 96 and/or the operation display panel 181.

The image Im1 includes images Im11, Im12, and Im13. The image Im11 can be clicked with a cursor or a touch operation can be input thereto. For example, while specimen preparation is being performed in the specimen preparation device 1, the opening and closing member 192 is locked in the closed state, and the worker can unlock the opening and closing member 192 by performing an operation input to the image Im11. As a result, the worker can open and close the opening and closing member 192 by moving the opening and closing member 192 up and down.

In the present example, it is assumed that six housing portions 1312 are provided in the rack 131, and here, six images Im12 indicate states of six cases 1311 in the rack 131, respectively.

Each of the images Im12 indicates whether or not the case 1311 is housed in the corresponding housing portion 1312 and in a case where the case 1311 is housed in the corresponding housing portion 1312, whether or not the observation specimen SPL can be housed in the case 1311 by the transfer unit 14. For example:
an image Im12a indicates that the case 1311 is not housed;
an image Im12b indicates that the case 1311 is housed and the observation specimen SPL can be housed in the case 1311 (there is an empty space for housing the observation specimen SPL); and
an image Im12c indicates that the case 1311 is housed but the observation specimen SPL cannot be housed in the case 1311 (the case 1311 is already filled with the observation specimens SPL).

The image Im12 described above is displayed on the basis of the detection result of the sensor 84, but may be displayed on the basis of the detection result of another known sensor. For example, as illustrated in FIGS. 16A and 16B, the sensor 84 may be used as a first sensor 84, and a second sensor 84b that detects the presence or absence of the case 1311 may be provided. Additionally and incidentally, the third sensor 84c that detects the position of the opening and closing member 192 may be provided, and in this case, the image Im12 may further indicate the open and closed states of the opening and closing member 192.

The specimen preparation in the specimen preparation device 1 is controlled on the basis of the detection results of the sensors 84, 84b, and 84c described above, and can be suppressed or interrupted in a case where the state of the device does not meet the criteria. For example, the control unit 173 (or 172) can output a stop command to stop the operation of the transfer unit 14.

As an example, during the transfer operation of the transfer unit 14, the opening and closing member 192 is in the closing state (The third sensor 84c outputs an ON signal.), the case 1311 is appropriately present (The second sensor 84b outputs an ON signal.), and the observation specimen SPL can be housed (The first sensor 84 outputs an OFF signal or an ON signal. Note that the first sensor 84 outputs an OFF signal in a state where there is no observation specimen SPL.).

Thereafter, for example, when the worker takes out the case 1311 to collect the observation specimen SPL, the opening and closing member 192 is brought into the open state (The third sensor 84c outputs an OFF signal.), and the case 1311 is taken out together with the observation specimen SPL (The first and second sensors 84 and 84b output OFF signals.), that is, all of the first to third sensors 84, 84b, and 84c output OFF signals.

In a case where all the observation specimens SPL are collected from this state, and in a case where the empty case 1311 is inserted again (The first sensor 84 outputs an OFF signal, and the second sensor 84b outputs an ON signal.), it is said that the transfer by the transfer unit 14 can be resumed. Therefore, in such a case, the output of the stop command can be suppressed.

On the other hand, in a case where all the observation specimens SPL are not collected, and in a case where the case 1311 in which a part of the observation specimens SPL remains is inserted again (The first sensor 84 outputs an ON signal, and the second sensor 84b also outputs an ON signal.), it is said that the resume of the transfer by the transfer unit 14 should be prevented to avoid mixing the observation specimens SPL. Therefore, in a case where after all the first to third sensors 84, 84b, and 84c output OFF signals, the first sensor 84 outputs an ON signal when the second and third sensors 84b and 84c output ON signals, the stop command can be output.

In such a configuration, the control unit 173 also functions as a determination unit that determines whether or not to output a stop command, and performs the determination on the basis of the detection results of the sensors 84, 84b, and 84c described above. By executing such control, it is possible to appropriately prevent a situation not intended by the worker, such as erroneous management of the observation specimen SPL and erroneous preparation of the observation specimen SPL.

Furthermore, here, six images Im13 indicate the types of the six cases 1311 described above, respectively. For example, each of the images Im13 indicates any of the types A to C of the observation specimens SPL to be housed in the case 1311 that has been housed or is housed in the corresponding housing portion 1312. For example, the image Im13a indicates that the type of the observation specimen SPL to be housed in the case 1311 of the corresponding housing portion 1312 is “type A”. These types A to C may be, for example, sites of the observation object OB, types of tests for the observation object OB, or other uses. Here, three types, that is, types A to C are exemplified, but two or less types or four or more types may be used.

According to such a configuration, for example, the worker can relatively easily recognize the use of the observation specimen SPL housed in each case 1311 and the empty state of each case 1311, thereby appropriately managing the observation specimens SPL in units of cases 1311.

### Summary of Embodiments

As described above, according to the present embodiment, the specimen storage unit (the specimen storage) 13 includes the opening and closing member 192 and the abutting member 81, and can thus store the observation specimen SPL obtained by providing the observation object OB on the plate PL. The opening and closing member 192 is a sliding door slidably attached to the main body of the specimen storage unit 13 in one direction (the Z direction in this case). The abutting member 81 is rotatably fixed to the main body of the specimen storage unit 13, abuts on the case 1311 when the opening and closing member 192 is in the closed state, and is separated from the case 1311 when the opening and closing member 192 is in the open state. According to such a configuration, the case 1311 that houses the observation specimen SPL is fixed at a predetermined position by the abutting member 81 in a case where the opening and closing member 192 is in the closed state. As a result, it is possible to appropriately store the observation specimen SPL in the case 1311, and the transfer unit 14 can appropriately transfer the observation specimen SPL from the transfer unit 121 to the specimen storage unit 13.

Although the opening and closing member 192 is a sliding door in the present embodiment, the opening and closing member 192 may be a door of another type, for example, may be a rotary door similarly to the other opening and closing members 191, 194, and 195. In the case of the rotary door, since the rotation shaft rotates at the time of opening and closing, the engaging portion 82 can be attached to the rotation shaft, thereby rotating with the rotation of the rotation shaft. Furthermore, the engaged portion 83 can be attached to the abutting member 81 so as to be engaged with the rotating engaging portion 82.

That is, the engaging portion 82 and the engaged portion 83 can be installed so as to be engaged or interfered with each other during the opening and closing of the opening and closing member 192 regardless of the type of door.

In the above description, each element is indicated by a name related to its function for facilitating understanding, but each element is not limited to the one having the content described in the embodiment as a main function, and may be the one having the content as an auxiliary function. In addition, the individual terms described herein are merely used for the purpose of describing the present invention, that is, the present invention is not limited to the strict meaning of the terms. For example, the term “apparatus” may be replaced with a term “unit/assembly/device/module”, or vice versa. In addition, for example, instead of the term “move” with respect to a symmetric object, it may be expressed as “convey“/”transfer” or the like, and vice versa.

The invention is not limited to the foregoing embodiments, and various variations/changes are possible within the spirit of the invention.

### REFERENCE SIGNS LIST

13 Specimen storage (specimen storage unit)
PL Plate
OB Observation object
SPL Observation specimen
192 Opening and closing member
81 Abutting member

1. A specimen storage for storing an observation specimen obtained by providing an observation object on a plate, the specimen storage comprising:
a case placement portion configured to place a case for housing an observation specimen;
a main body that includes an opening communicating so as to allow the case to move;
an opening and closing member that is movably attached to the main body in one direction;
an abutting member configured to be able to abut on one of the cases for housing observation specimens; and
a movement mechanism that moves the opening and closing member, wherein
the opening and closing member is provided to be movable between an open position at which the opening is opened and a closed position at which the opening is closed,
the abutting member is provided to be movable to an abutting position at which the abutting member abuts on the case placed in the case placement portion and a separated position at which the abutting member is separated from the case so as to be able to take out the case from the case placement portion, and
the movement mechanism moves the abutting member based on movement of the opening and closing member.

2. The specimen storage according to claim 1, wherein
the movement mechanism moves the abutting member to the abutting position based on movement of the opening and closing member to the closed position, and moves the abutting member to the separated position based on movement of the opening and closing member to the open position.

3. The specimen storage according to claim 1, wherein
the movement mechanism includes
an engaging portion attached to the opening and closing member, and
an engaged portion that is attached to the abutting member and engaged with the engaging portion.

4. The specimen storage according to claim 3, wherein
the engaged portion includes a first engaged portion and a second engaged portion,
the first engaged portion is engaged with the engaging portion when the opening and closing member moves from the open position to the closed position, and
the second engaged portion is engaged with the engaging portion when the opening and closing member moves from the closed position to the open position.

5. The specimen storage according to claim 4, wherein
the engaged portion further includes a coupling portion fixed to the abutting member, and the first engaged portion extending from one side of the coupling portion and the second engaged portion extending from the other side of the coupling portion constitute a C-shaped arm member, and
the case placement portion includes a rotation support portion that rotatably supports the abutting member.

6. The specimen storage according to claim 5, wherein
the engaged portion is installed in a manner that
when the opening and closing member is located at the open position, the first engaged portion is located within a movement trajectory of the engaging portion, and the second engaged portion is located outside the movement trajectory of the engaging portion, and
when the opening and closing member is located at the closed position, the second engaged portion is located within the movement trajectory of the engaging portion.

7. The specimen storage according to claim 1, wherein
the case placement portion further includes
a first defining portion that defines a position of one of the cases in an insertion and removal direction in which the case can be inserted into and removed from the case placement portion, and
a second defining portion that defines a position of the case in a direction orthogonal to the insertion and removal direction.

8. The specimen storage according to claim 1, wherein
the opening and closing member is configured to be movable in a vertical direction, and
the main body includes
a movement assist mechanism that assists movement of the opening and closing member in the vertical direction, and
an opening and closing member holding portion that holds the opening and closing member at the closed position.

9. The specimen storage according to claim 1, wherein
the cases are configured to be able to house one or more observation specimens,
the main body includes
a first sensor that detects presence or absence of an observation specimen held in a case, and
a second sensor that detects presence or absence of a case placed in the case placement portion.

10. A specimen storage device comprising:
the specimen storage according to claim 9; and
a state display unit that displays a state of the specimen storage, wherein the state display unit displays, for each of a plurality of the cases arranged in a predetermined direction, presence or absence of an observation specimen and/or presence or absence of a case based on detection results of the first sensor and the second sensor.

11. The specimen storage device according to claim 10, further comprising a third sensor that detects a position of the opening and closing member, wherein
the state display unit displays that the opening and closing member is located at the closed position based on a detection result of the third sensor.

12. The specimen storage device according to claim 11, comprising:
a transfer unit that transfers an observation specimen to one of the cases; and
a control unit that executes drive control of the transfer unit, the specimen storage device wherein
the control unit executes drive control of the transfer unit based on detection results of the first sensor, the second sensor, and the third sensor.

13. The specimen storage device according to claim 12, wherein
the control unit includes a determination unit that determines whether or not to output a stop command to stop an operation of the transfer unit,
the first sensor outputs an ON signal in a case where the observation specimen is present, and outputs an OFF signal in a case where the observation specimen is not present,
the second sensor outputs an ON signal in a case where one of the cases is present, and outputs an OFF signal in a case where the case is not present, and
the third sensor outputs an ON signal in a case where the opening and closing member is at the closed position, and outputs an OFF signal in a case where the opening and closing member is not at the closed position, and
the determination unit outputs a stop command in a case where the first sensor outputs an ON signal when the second sensor and the third sensor output an ON signal from a state where all the first sensor, the second sensor, and the third sensor output an OFF signal.

14. A specimen preparation device comprising:
the specimen storage device according to claim 12;
a plate storage unit that stores a plate before the observation object is provided;
an observation object provision unit that is used when the observation object is provided onto the plate; and
a post-processing unit that performs post-processing on the plate after the observation object is provided, wherein
the transfer unit receives the plate as the observation specimen from the post-processing unit and transfers the plate to the case placed in the case placement portion.

15. The specimen storage according to claim 1, wherein
the abutting member retains the case at a predetermined position when the abutting member is at the abutting position.
